(19) United States
(12) Patent Application Publication
(10) Pub. No.: US 2026/0346139 A1
(43) Pub. Date: Nov. 5, 2026

(54) METHOD AND APPARATUS FOR UPDATING RESOURCES IN AUTO CHESS, TERMINAL, AND STORAGE MEDIUM

(71) Applicant: Tencent Technology (Shenzhen) Company Limited, Shenzhen (CN)

(72) Inventors: Qiankun LIANG, Shenzhen (CN); Yanan ZHANG, Shenzhen (CN)

(21) Appl. No.: 19/706,889

(22) Filed: Jun. 12, 2026

Related U.S. Application Data
(63) Continuation of application No. PCT/CN2025/075763, filed on Feb. 5, 2025.

(30) Foreign Application Priority Data
Feb. 8, 2024 (CN) 202410178244.2

(51) Int. Cl. A63F 13/52; A63F 13/55; A63F 13/69; A63F 13/79; A63F 13/822

(52) U.S. Cl. CPC A63F 13/52; A63F 13/55; A63F 13/69; A63F 13/79; A63F 13/822

(57) ABSTRACT

Provided is a method for updating resources in an auto chess performed by a computer device. The method includes: displaying an auto chess battle picture, the auto chess battle picture including a board area configured to display a deployed virtual piece and a card area configured to display unused virtual cards; in response to a use operation on a first virtual card in the card area: displaying a first virtual piece corresponding to the first virtual card in the board area and reducing virtual resources by a first quantity, the first quantity being a resource consumption amount for using the first virtual card; and in response to a deletion operation on a second virtual card in the card area, increasing the virtual resources by a second quantity and deleting a second virtual card from the card area, the second quantity being greater than the first quantity.

### CROSS-REFERENCE TO RELATED APPLICATIONS

This application is a continuation application of PCT Patent Application No. PCT/CN2025/075763, entitled “METHOD AND APPARATUS FOR UPDATING RESOURCES IN AUTO CHESS, TERMINAL, AND STORAGE MEDIUM” filed on Feb. 5, 2025, which claims priority to Chinese Patent Application 202410178244.2, entitled “METHOD AND APPARATUS FOR UPDATING RESOURCES IN AUTO CHESS, TERMINAL, AND STORAGE MEDIUM” and filed on Feb. 8, 2024, both of which are incorporated herein by reference in their entirety.

### FIELD OF THE TECHNOLOGY

Embodiments of this application relate to the field of human-computer interaction, and in particular, to a method and apparatus for updating resources in an auto chess, a terminal, and a storage medium.

### BACKGROUND OF THE DISCLOSURE

Auto chess is a tactically strategic electronic game in which a game player is required to deploy character pieces and arrange their positions in advance reasonably, so that the current player's character pieces can defeat all character pieces of the opposing player during the automatic combat process of a virtual battle.

In the related art, a game player can obtain virtual resources based on the outcome of a virtual battle, or can obtain virtual resources by removing deployed character pieces, where the virtual resources are typically associated with the battle state of virtual pieces.

However, the resource updating mechanism of auto chess games has a high threshold for understanding. Due to the constraints of the virtual battle, the above-mentioned resource acquisition process also introduces a particular degree of randomness in the virtual resources that the game player can obtain. Consequently, the process for the game player to calculate the virtual resources is cumbersome, resulting in excessively low human-computer interaction efficiency.

### SUMMARY

Embodiments of this application provide a method and apparatus for updating resources in an auto chess, a terminal, and a storage medium. The technical solutions are described in the following aspects.

In an aspect, an embodiment of this application provides a method for updating resources of a first player account in an auto chess performed by a computing device and the method including:
displaying an auto chess battle picture, the auto chess battle picture including a board area configured to display a deployed virtual piece and a card area configured to display unused virtual cards;
in response to a use operation on a first virtual card in the card area, displaying a first virtual piece corresponding to a first virtual card in the board area and reducing virtual resources by a first quantity, the first quantity being a resource consumption amount for using the first virtual card; and
in response to a deletion operation on the second virtual card in the card area, increasing the virtual resources by a second quantity and deleting a second virtual card from the card area, the second quantity being greater than the first quantity.

In another aspect, an embodiment of this application provides a computer device, including a processor and a memory, the memory having at least one instruction stored therein, and the at least one instruction being loaded and executed by the processor to implement the method for updating resources of a first player account in an auto chess as described in the above aspect.

In another aspect, an embodiment of this application provides a non-transitory computer-readable storage medium, having at least one instruction stored therein, and the at least one instruction being loaded and executed by a processor to implement the method for updating resources of a first player account in an auto chess as described in the above aspect.

In another aspect, an embodiment of this application provides a computer program product, including computer instructions, the computer instructions being stored in a computer-readable storage medium, and a processor acquiring the computer instructions from the computer-readable storage medium and executing the computer instructions to implement the method for updating resources in an auto chess as described in the above aspect.

The method provided in this embodiment can achieve, in addition to displaying the first virtual piece corresponding to the first virtual card in the board area and consuming the first quantity of virtual resources via the use operation on the first virtual card in the card area, the resource acquisition process of acquiring the second quantity of virtual resources exchanged with the second virtual card via the deletion operation on the second virtual card in the card area. This process not only enables the virtual card in the card area to be used, but also enables the virtual card to be specifically exchanged for the virtual resources, thereby enriching resource acquisition manners. Compared with a dynamically changed virtual piece during a virtual battle process, the exchange relationship between a static virtual card and virtual resources has high stability. Therefore, the second quantity of virtual resources obtained by exchange based on the virtual card is stable. The problem of resource acquisition complexity caused by excessively strong randomness in a game process is avoided so that a game player can understand the resource exchange process more efficiently. Thus, the human-computer interaction efficiency is improved.

According to the method provided in this embodiment, while eliminating the virtual store in traditional auto chess based on the playstyle characteristics of the cards, the cumbersome process in which a game player previously needed to purchase desired pieces from dozens of available pieces in the virtual store is replaced with a process in which the game system automatically deals virtual cards to the game player. This eliminates the need for the game player to manually select cards, thereby reducing the number of interactive operations required for the game player to acquire pieces, as well as the amount of information that the user needs to process.

According to the method provided in this embodiment, the virtual resources may alternatively be acquired by deleting the virtual cards, thereby enriching the ways to acquire the virtual resources and enriching strategies for auto chess games. Moreover, when a virtual card is deleted, the virtual resources are increased by a fixed quantity. This eliminates the need to calculate the quantity of resources increased or reduced according to the quality of the virtual cards, facilitating game players in quickly calculating the virtual resources and, hence making relevant decisions. Thus, the human-computer interaction efficiency is further improved.

### BRIEF DESCRIPTION OF THE DRAWINGS

FIG. 1 is a structural block diagram of a computer system according to this application.

FIG. 2 is a flowchart of a battle interaction method for a turn-based board game provided by an embodiment of this application.

FIG. 3 is a schematic diagram of a battle interface of a turn-based board game provided by an embodiment of this application.

FIG. 4 is a schematic diagram of a piece card provided by an embodiment of this application.

FIG. 5 is a schematic diagram of an effect card provided by an embodiment of this application.

FIG. 6 is a schematic diagram of an equipment card provided by an embodiment of this application.

FIG. 7 is a schematic diagram of a player card provided by an embodiment of this application.

FIG. 8 is a flowchart of a battle interaction method for a turn-based board game provided by an embodiment of this application.

FIG. 9 is a schematic diagram of a player selection interface provided by an embodiment of this application.

FIG. 10 is a schematic diagram of a battle interface during a preparation phase provided by an embodiment of this application.

FIG. 11 is a schematic diagram of an interface when a card is played during a preparation phase provided by an embodiment of this application.

FIG. 12 is a schematic diagram of a level-up process of a level-up button provided by an embodiment of this application.

FIG. 13 is a schematic diagram of a level-up process of a level-up button provided by an embodiment of this application.

FIG. 14 is a schematic diagram of a battle interface during a battle phase provided by an embodiment of this application.

FIG. 15 is a schematic diagram of a settlement interface provided by an embodiment of this application.

FIG. 16 is a flowchart of a method for updating resources in an auto chess provided by an exemplary embodiment of this application.

FIG. 17 is a schematic diagram of a resource updating interface when a virtual card is used provided by an exemplary embodiment of this application.

FIG. 18 is a schematic diagram of a resource updating interface when a virtual card is deleted provided by an exemplary embodiment of this application.

FIG. 19 is a schematic diagram of a deletion confirmation prompt interface provided by an exemplary embodiment of this application.

FIG. 20 is a schematic diagram of a batch deletion prompt interface provided by an exemplary embodiment of this application.

FIG. 21 illustrates a flowchart of a method for updating resources in an auto chess provided by another exemplary embodiment of this application.

FIG. 22 illustrates a schematic diagram of changes of a personal deck and a global deck provided by an exemplary embodiment of this application.

FIG. 23 illustrates a schematic diagram of changes of a personal deck and a global deck provided by another exemplary embodiment of this application.

FIG. 24 illustrates a schematic diagram of a process of determining a personal deck provided by another exemplary embodiment of this application.

FIG. 25 illustrates a structural block diagram of an apparatus for updating resources in an auto chess provided by an exemplary embodiment of this application.

FIG. 26 illustrates a structural block diagram of a terminal provided by an exemplary embodiment of this application.

### DESCRIPTION OF EMBODIMENTS

First, terms involved in the embodiments of this application are briefly introduced as follows:

Turn-Based Board Game: It refers to a board game in which pieces (virtual pieces) are pre-arranged before the battle, and during the battle, the pieces automatically engage in combat according to the pre-arrangement. The “pieces” are typically represented by virtual characters, which may be referred to, for example, as virtual heroes. During the battle, the virtual characters automatically cast various skills to battle. The battle is typically turn-based. When all pieces on one side are defeated (i.e., the health points of the virtual character are reduced to zero), this side is considered the loser of the current turn. In some embodiments, in addition to the “piece type virtual characters” used for a virtual battle, each of the two opposing sides is further provided with a player character representing the current user participating in the battle. The player character cannot be moved to the battle area or the piece candidate area as a “piece”. The player character is also assigned health points (or hit points). The health points of the player character are correspondingly reduced (in case of a battle loss) or remain unchanged (in case of a battle win) based on the outcome of each battle. When the health points of this virtual character are reduced to zero, the user corresponding to the player character withdraws from the battle, and the remaining users continue the battle. In one embodiment, the turn-based board game includes auto chess.

Auto Chess: It is a turn-based competitive multiplayer game with in-game trading of hero pieces. For example, the game involves eight or six game players, each occupying a designated area on the board. Two game players among a plurality of game players engage in a one-on-one battle. Each turn of a battle includes two phases: a preparation phase and a battle phase. During the preparation phase, the users purchase pieces (heroes) from a shop and arrange lineups on the board. During the battle phase, the lineups of both sides are locked, and the pieces automatically engage in combat until all pieces on one side are defeated.

Board: It refers to an area within the battle interface of a turn-based board game used for preparing for and conducting battles. The board may be any one of a two-dimensional virtual board, a 2.5-dimensional virtual board, and a three-dimensional virtual board. This is not limited in this application.

The board for traditional auto chess is divided into a battle area and a piece candidate area. The battle area includes a plurality of grid cells of the same size for holding pieces that engage in combat during the battle. The piece candidate area includes a plurality of candidate piece positions for holding candidate pieces that do not participate in combat during the battle and can be dragged and placed into the battle area during the preparation phase. The board area provided in the embodiments of this application excludes the piece candidate area but includes only the battle area.

Regarding the arrangement of grid cells in the battle area, in some embodiments, the battle area includes n (rows)×m (columns) grid cells. For example, n is an integer multiple of 2, and two adjacent rows of grid cells are aligned, or two adjacent rows of grid cells are staggered. Furthermore, the battle area is equally divided into two parts by rows, namely a current player's battle area and an opposing player's battle area. Users participating in battle are respectively located on the upper and lower sides of the battle interface, and during the preparation phase, a user can only place pieces in the current player's battle area. In some other embodiments, the battle area is equally divided into two parts by columns, namely a current player's battle area and an opposing player's battle area, and users participating in battle are respectively located on the left and right sides or the upper and lower sides of the battle interface.

Card: It is a common term for a type of game, originating from tabletop games. Unlike directly manipulating piece models when playing chess, a card carries the game's content on it. Compared to pieces, cards are more convenient for conveying textual descriptions, card attribute information, and some key numerical values. “Cardification” refers to representing hero resources as card resources, thereby facilitating game players in reading and categorizing card effects, and conveying information across more dimensions.

Energy: It is a form of resources in games. In this application, energy is defined as a resource used by the game player to play cards. Playing a particular card requires consuming the corresponding amount of energy indicated on the card.

Equipment: In auto chess games each piece may wear 3 (or other numbers) pieces of equipment. Equipment may provide attributes or effects to the hero, such as attack, defense, health points, healing, penetration, and shield. Auto chess games in the related art typically include a neutral creep round. Game players obtain equipment dropped by defeating neutral creeps and pick up the equipment into backpacks. Equipment may alternatively be synthesized from basic components to obtain higher-quality equipment.

Player: It refers to a virtual character played by a game player. Each player possesses different abilities that can assist the game player in playing the game more effectively.

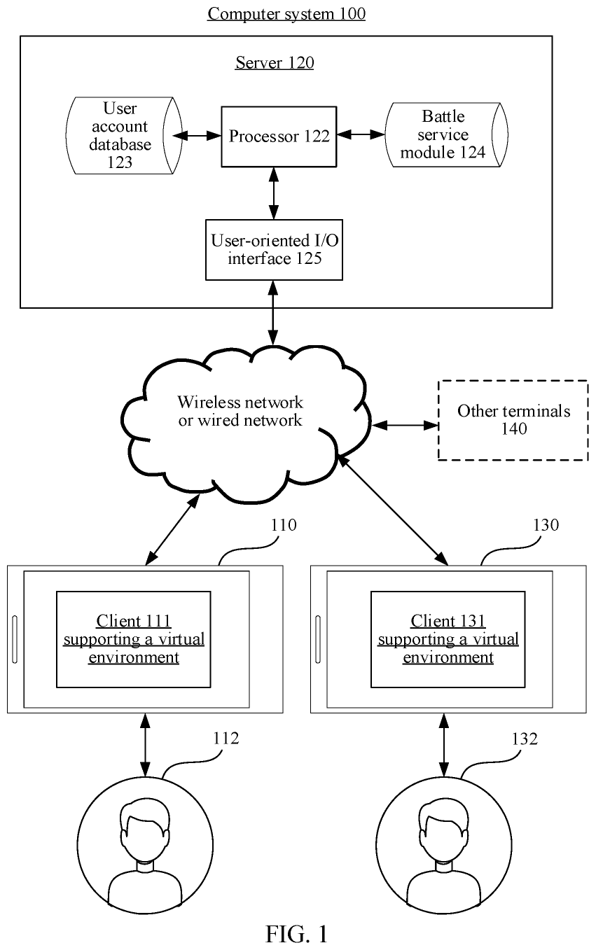

FIG. 1 illustrates a structural block diagram of a computer system provided by an exemplary embodiment of this application. The computer system 100 includes a first terminal 110, a server 120, and a second terminal 130.

A client 111 supporting a virtual environment is installed and runs on the first terminal 110. The client 111 may be a program of a turn-based board game. When the first terminal runs the client 111, a user interface of the client 111 is displayed on the screen of the first terminal 110. The client may be a client of an auto chess game. The first terminal 110 is a terminal used by a first user 112. The first user 112 arranges pieces in the battle area of the board by using the first terminal 110 during the preparation phase of a battle. The first terminal 110 or the server 120 automatically controls the pieces to battle during the battle phase according to the attributes, skills, and the arrangement of the pieces in the battle area.

A client 131 supporting a virtual environment is installed and runs on the second terminal 130. The client 131 may be a program of a turn-based board game. When the second terminal 130 runs the client 131, a user interface of the client 131 is displayed on the screen of the second terminal 130. The client may be a client of an auto chess game. The second terminal 130 is a terminal used by a second user 132. The second user 132 arranges pieces in the battle area of the board by using the second terminal 130 during the preparation phase of a battle. The second terminal 130 or the server 120 automatically controls the pieces to battle during the battle phase according to the attributes, skills, and the arrangement of the pieces in the battle area. In one embodiment, the pieces arranged by the first user via the first terminal 110 and those arranged by the second user via the second terminal 130 are located in different battle areas on the same board. To be specific, the first user and the second user are in the same board within the same battle. Alternatively, the pieces arranged by the first user via the first terminal 110 and those arranged by the second user via the second terminal 130 are located on different boards. In an exemplary embodiment, a single battle of the turn-based board game involves six user accounts. In each turn, the six user accounts are paired up, and the two user accounts that are paired together engage in a battle on the same board during this turn.

In one embodiment, the clients installed on the first terminal 110 and the second terminal 130 are the same, or the clients installed on the two terminals are the same type of clients on different operating system platforms (Android or IOS). The first terminal 110 may refer to one of a plurality of terminals, and the second terminal 130 may refer to another one of the plurality of terminals. This embodiment uses only the first terminal 110 and the second terminal 130 as an example for description. The first terminal 110 and the second terminal 130 are of the same or different device types, including at least one of a smartphone, a tablet computer, an e-book reader, a moving picture experts group audio layer III (MP3) player, a moving picture experts group audio layer IV (MP4) player, a laptop computer, and a desktop computer. In the following embodiment, an example in which a terminal includes a smartphone is used for description. The number of terminals and the device types are not limited in the embodiments of this application.

Only two terminals are shown in FIG. 1. However, in different embodiments, there may be a plurality of other terminals 140 that can access the server 120.

The first terminal 110, the second terminal 130, and the other terminals 140 are connected to the server 120 via a wireless network or a wired network. The server 120 includes at least one of one server, a plurality of servers, a cloud computing platform, and a virtualization center. The server 120 is configured to provide a background service for a client supporting a three-dimensional virtual environment (a client of a turn-based board game/a client of an auto chess game).

In an exemplary embodiment, the server 120 includes a processor 122, a user account database 123, a battle service module 124, and a user-oriented input/output (I/O) interface 125. The processor 122 is configured to load instructions stored on the server 120, and process data in the user account database 123 and the battle service module 124. The user account database 123 is configured to store data of user accounts used by the first terminal 110, the second terminal 130, and the other terminals 140. The battle service module 124 is configured to provide a plurality of battle rooms for users to battle. The user-oriented I/O interface 125 is configured to establish communication with the first terminal 110 and/or the second terminal 130 via a wireless network or a wired network for data exchange.

An embodiment of this application provides a turn-based board game (auto chess) operating based on cards. The various complex operations involved in traditional auto chess, such as store purchase, store leveling up, piece preparation, piece deployment, piece leveling up, and piece equipment, are all simplified within the playing process of cards. On the one hand, the playing process based on cards is simple and well-suited for use on small-screen terminals such as mobile phones and tablets. On the other hand, the face of a card can carry more information, such as “label”, “value”, “attribute”, and “affix effect”, than a virtual piece, thereby improving the utilization efficiency of the display area where the card is located.

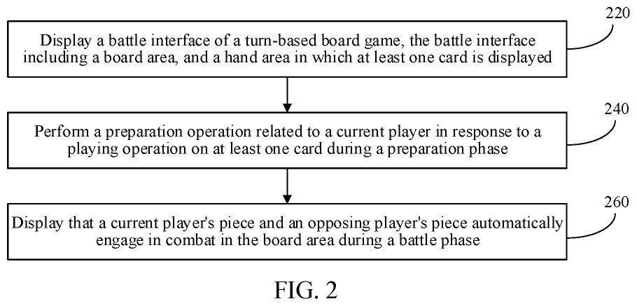

FIG. 2 illustrates a flowchart of a battle interaction method for a turn-based board game provided by an exemplary embodiment of this application. The method is performed by a computing device. In this embodiment, an example in which the method is performed by a terminal is used for description. A client supporting the turn-based board game runs on the terminal. The method includes the following operations:
Operation 220: Display a battle interface of a turn-based board game, the battle interface including a board area, and a card area in which at least one card is displayed.

The battle interface is an interface in which two game player objects engage in a turn-based battle in the turn-based board game. The game player object may be understood as at least one of the following concepts: a user, an account, a game player, a player, and a virtual player.

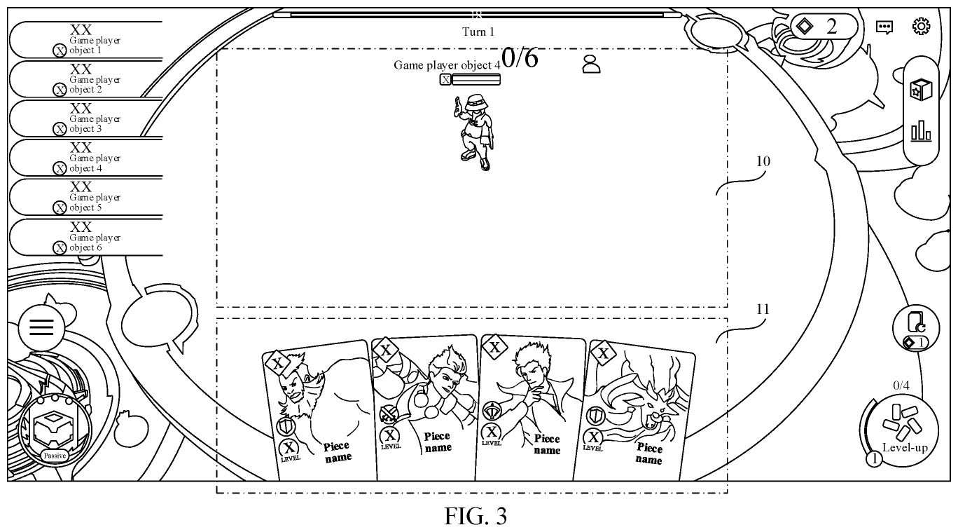

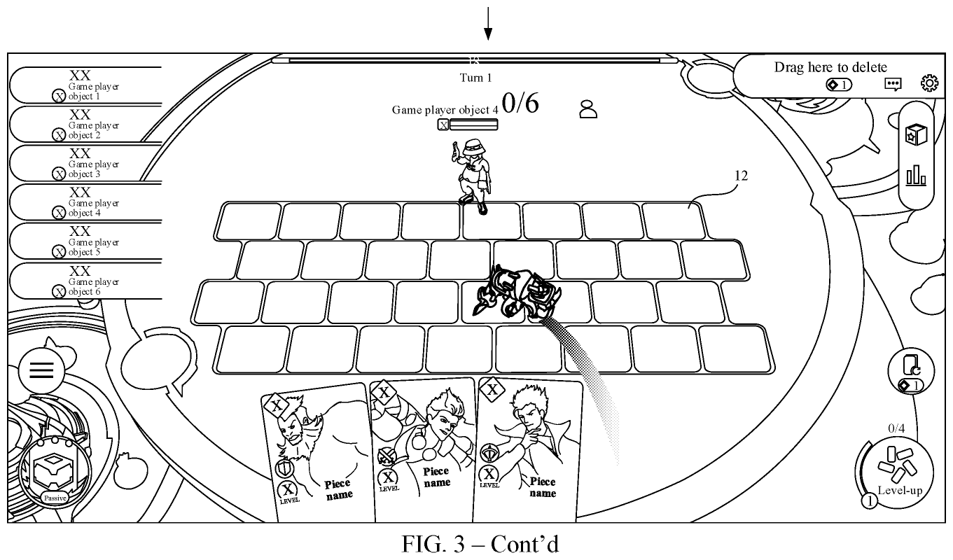

Referring to FIG. 3, the battle interface includes a board area 10 and a card area 11. The board area 10 is configured to accommodate at least one current player's piece and at least one opposing player's piece participating in the battle. The board area 10 includes a plurality of grid cells 12 arranged in an array, and these grid cells 12 are either always displayed or displayed only at particular times. In one embodiment, the board area 10 is a two-dimensional board or a three-dimensional board. The three-dimensional board herein means that the board is located in a three-dimensional environment, rather than the board itself necessarily being in a three-dimensional form. The card area 11 is configured to display at least one card held by or dealt to the current game player object. The at least one card includes at least one of the following: cards automatically drawn or dealt to the current game player object by a background program, cards obtained after playing particular cards with a card-drawing effect, and player cards obtained because of a player skill. There may be an upper limit for the number of the plurality of cards. In one embodiment, the plurality of cards are arranged in a fan shape within the card area 11. The arrangement order may be determined based on at least one factor such as the time of drawing, the card type, the number of cards of the same type, the number of copies of the same card, or the quality level of the card. In one embodiment, there is an upper limit for the number of the at least one card held by the current game player object, with any cards exceeding the upper limit being discarded. The current game player object may play all or part of the cards in each turn. In one embodiment, in each turn, the current game player object may alternatively replace all or part of the cards. In one embodiment, different cards have different card types. Different card types have different preparation functions.

A single battle of the turn-based board game includes a plurality of turns. Each turn includes a preparation phase and a battle phase.
Operation 240: Perform a preparation operation related to the current player in response to a playing operation on at least one card during the preparation phase.

The playing operation refers to an operation of playing one or more cards held. For example, the playing operation is an operation of dragging a selected card toward the board area. Alternatively, the playing operation includes a first clicking/tapping operation and a second clicking/tapping operation. The first clicking/tapping operation is an operation of clicking/tapping to select a card, and the second clicking/tapping operation is an operation of clicking/tapping on a grid cell in the board area. The specific form of the playing operation is not limited in the embodiments of this application. In some embodiments, a function of intelligently recommending cards to play may further be provided, which plays cards on behalf of the current game player object in particular turns. For example, in the first few turns for a novice game player, the client may intelligently recommend cards to play.

At least one current player's piece refers to a virtual piece that participates in the battle in at least one turn (including the current turn). In an initial state, the number of current player's pieces located in the board area may be zero, and the current player's pieces may be added, removed, or replenished in the board area by the current game player object. The current player's pieces that survived the previous turn may be automatically carried over to the next turn.

The display state of a selected card is different from that of a non-selected card. In one embodiment, the selected card has a prominent display effect. The prominent display effect includes: a bold border, a highlighted border, a dynamic border, and moving the card's position in the card queue toward the board area by a preset distance. The preparation operation includes at least one of the following: adding a current player's piece, removing a current player's piece, leveling up a current player's piece, equipping a current player's piece with equipment, removing equipment from a current player's piece, or adding a buff to a current player's piece. Since different card types have different effects, the preparation operation is performed on at least one current player's piece in the board area based on the card type of the selected card. During the preparation phase, the current game player object prepares at least one current player's piece in the board area, and an opposing game player object prepares at least one opposing player's piece in the board area.
Operation 260: Display that the current player's piece and the opposing player's piece automatically engage in combat in the board area during the battle phase.

The automatic combat process between the current player's piece and the opposing player's piece in the board area does not require manual control by the current game player object. Instead, the client or server automatically controls the combat between the pieces on both sides based on at least one factor such as the grid cell positions of the pieces on both sides on the board, piece attributes, piece levels, piece skills, piece attributes, and combined enhancement attributes between pieces, until all pieces on one side are defeated. Both the current game player object and the opposing game player object have health points. After the current turn ends, the health points of the game player object on the losing side will be deducted by a particular amount. The particular amount may be determined based on the number of remaining pieces on the winning side, or may be a fixed value. This is not limited in this embodiment.

In conclusion, a “card” mechanism is introduced into the turn-based board game, simplifying and integrating various preparation operations into the process of playing a plurality of cards. The concept of a virtual store is eliminated, and the game player no longer needs to perform a plurality of interactions between sub-areas such as a store, a piece preparation area, and a piece battle area on a traditional battle interface to complete the acquisition, leveling up, and battling of pieces. The traditional process of purchasing pieces that required active selection by the user is replaced by passively receiving dealt cards, whereby the game system performs part of the tedious operations on behalf of the user. The user only needs to perform playing operations similar to those in card games to complete various preparation operations. Thus, the human-computer interaction efficiency is improved. In particular, when operating the turn-based board game on a small-screen terminal such as a mobile phone or a tablet, the game player can complete various preparation operations based on limited operations within the card area. Compared to traditional auto chess, the human-computer interaction efficiency is significantly improved.

### Classification of Card Types

In one embodiment, the card types include at least one of the following: piece cards, effect cards, equipment cards, and player cards.

### Piece Card:

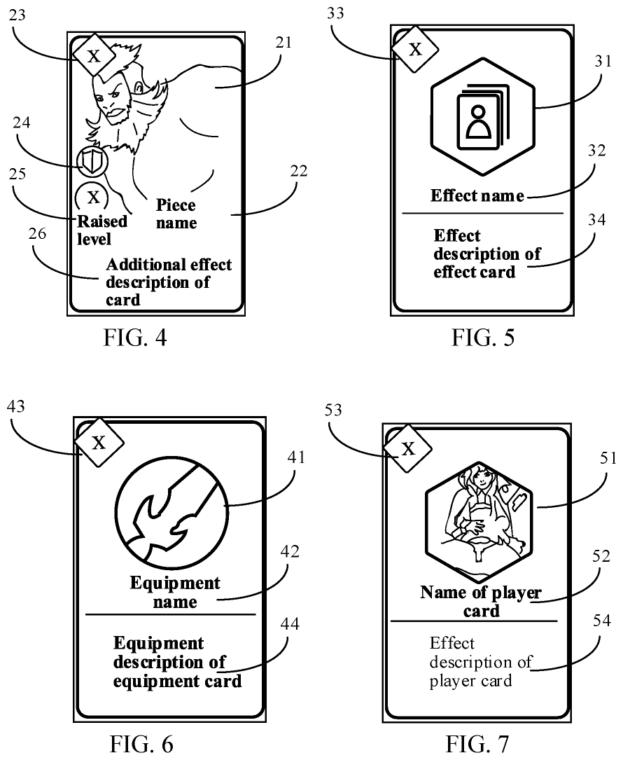

A piece card is a card configured to summon a current player's piece in the board area or to level up a current player's piece. FIG. 4 illustrates a schematic diagram of a piece card. The piece card displays at least one of the following information: a piece representation 21, a piece name 22, an energy value 23 consumed when playing the card, a piece type or faction 24 to which the piece belongs, a level 25 to which the piece is raised after playing the card, and an additional effect description 26 of the piece.

The piece representation 21 may be at least one of an avatar, an icon, a half-body portrait, a full-body portrait, or a display animation of the virtual piece. FIG. 4 illustrates an example in which the piece representation 21 is a half-body portrait of the virtual piece. The piece name 22 is the name of the virtual piece. Taking as an example that the virtual piece is a hero, the piece name is a hero name. The energy value 23 refers to the energy value to be consumed when playing the piece card, and the energy value is an integer. Energy is a type of resource in the turn-based board game. In one embodiment, cards of different qualities require different amounts of energy to be consumed when played. The piece type 24 is a classification attribute of a character played by a piece in a battle process. In an example, different pieces may be classified into at least one piece type of a tank, a warrior, an assassin, a mage, a marksman, and a support. A faction is a classification attribute that pieces belong to the same piece group in the virtual world view. The piece type and the faction may be considered as the same classification attribute. In this embodiment, an example in which the piece type and the faction are different classification attributes is used.

The level 25 to which the piece is raised after playing the card refers to the piece level to which an existing piece with the same name (i.e., the same piece) in the board area is raised after the card is played. For example, if the level 25 is level 3 and the piece with the same name was originally at level 2, the piece with the same name is raised to level 5 after the card is played. In one embodiment, the piece with the same name is raised to different levels after cards of different qualities are played. For example, the piece with the same name is raised to levels 1, 2, 3, 4, and 5 after cards of five different qualities are played, respectively. The additional effect description 26 of a piece is an effect description of the additional effect possessed by the piece. The additional effect may take effect immediately when the card is played, or may take effect when a particular trigger condition is satisfied during the battle process.

### Effect Card:

An effect card is a card configured to apply an effect to at least one game factor within a game battle, the at least one game factor including a piece, a skill, equipment, a buff, a level, a combat process, a card acquisition process, and the like. FIG. 5 illustrates a schematic diagram of an effect card. The effect card displays at least one of the following information: an effect icon 31, an effect name 32, an energy value 33 consumed when playing the card, and an effect description 34 of the effect card.

The effect icon 31 may be an icon representing the buff of the effect card. FIG. 5 illustrates an example in which the icon has a hexagonal frame. The effect name 32 is the name of the effect card or the name of the buff. The energy value 33 refers to the energy value to be consumed when playing the effect card, and the energy value is an integer. Energy is a type of resource in the turn-based board game. In one embodiment, cards of different qualities require different amounts of energy to be consumed when played. The effect description 34 of the effect card is configured to describe the effect of the effect card after being used. The effect of the effect card includes, but is not limited to, at least one of: 1, enhancing the probability of acquiring piece cards for the current player and/or increasing the number thereof; 2, enhancing the probability of acquiring piece cards with the same name as a piece on the board for the current player or increasing the number thereof; 3, reducing the energy required for the current player to acquire piece cards; 4, increasing the number of piece cards traded by the current player; 5, reducing the energy required for the current player to trade piece cards; 6, raising the level of at least one piece on the board; 7, adding equipment to at least one piece on the board; 8, leveling up the equipment for at least one piece on the board; 9, reducing energy consumption when playing/exchanging cards; 10, increasing the probability of acquiring particular cards; 11, increasing the number of particular cards acquired; 12, increasing the number of exchange opportunities, and so on, without exhaustive listing. For example, the effect of a “Duo” card is to randomly obtain 2 identical hero cards. The effect of a “Talent Search” card is to choose 1 from 3 hero cards of the highest quality available at the current player level. The effect of a “Copy” card is to randomly obtain one card with the same name as a hero on the board.

In some embodiments, effect cards may be classified into at least one of the following: general effect cards, piece type-specific effect cards, and faction-specific effect cards. A general effect card is an effect card of which the card attribute is not related to piece type or faction. The card attribute includes at least one of the following: acquisition condition, use condition, card effect, and action range. A piece type-specific effect card is an effect card of which the card attribute is related to piece type. A faction-specific effect card is an effect card of which the card attribute is related to faction. For example, a particular piece type-specific effect card can only be obtained with a particular probability when a piece card of this piece type is played.

### Equipment Card:

An equipment card is a card configured to equip at least one current player's piece with equipment. FIG. 6 illustrates a schematic diagram of an equipment card provided by an exemplary embodiment of this application. The equipment card displays at least one of the following information: an equipment icon 41, an equipment name 42, an energy value 43 consumed when playing the card, and an equipment description 44 of the equipment card.

The equipment icon 41 may be an icon configured for representing the appearance of equipment or the effect of equipment. FIG. 6 illustrates an example in which the icon has a circular frame. The equipment name 42 is the name of the equipment card or the name of the equipment. Different equipment can enhance the combat capability of current player's pieces in different dimensions such as hit points, armor, defense, and mana, or weaken the combat capability of opposing player's pieces. The energy value 43 refers to the energy value to be consumed when playing the equipment card. Energy is a type of resource in the turn-based board game. In one embodiment, cards of different qualities require different amounts of energy to be consumed when played. For example, cards of five different qualities require 0, 1, 2, 3, and 4 energy points, respectively, when played. In one embodiment, the energy values consumed by different cards may alternatively be adjusted periodically or a periodically based on game balance considerations. The equipment description 44 of the equipment card is configured to describe the effect of the equipment after it is equipped.

### Player Card:

A player card is a card obtained via a player skill of a player virtual character. The player card may be a card obtained by triggering a passive skill of the player virtual character, a card that can only be obtained by a particular player virtual character, a card that can only be used by a particular player virtual character, a card exclusive to a particular player virtual character, or the like. This is not limited in the embodiments of this application.

FIG. 7 illustrates a schematic diagram of a player card provided by an exemplary embodiment of this application. The player card displays at least one of the following information: a card icon 51, a player card name 52, an energy value 53 consumed when playing the card, and an equipment description 54 of the player card.

The card icon 51 may be an icon configured for representing a card effect. FIG. 7 illustrates an example in which the icon has a hexagonal frame. The player card name 52 is the name of the player card or the name of the effect. The energy value 53 refers to the energy value to be consumed when playing the player card, and the energy value is an integer. Energy is a type of resource in the turn-based board game. In one embodiment, cards of different qualities require different amounts of energy to be consumed when played. In one embodiment, the energy values consumed by different cards may alternatively be adjusted periodically or a periodically based on game balance considerations. The effect description 54 of the player card is configured to describe the effect that can be added after the player card is used. The effect of the player card may be the same as or similar to the effects of the piece card, the equipment card, and the effect card, and may alternatively go beyond the scope of the effects of the piece card, the equipment card, and the effect card. The effect of the player card may alternatively be designed as any form of effect, such as summoning a piece, leveling up a piece, adding equipment, adding a buff, reducing energy consumption, or affecting the card acquisition process. The effect of the player card may be designed to affect any process or detail in the game battle. This is not limited here.

Based on the introduction of the four types of cards described above:

On the one hand, different types of cards have different functions. With piece cards, the virtual store in traditional auto chess can be eliminated based on the playstyle characteristics of the cards. With the effect cards, the effect buttons or controls in traditional auto chess can be eliminated. With the equipment cards, the neutral creep round in traditional auto chess can be eliminated. With the player cards, gameplay characteristics related to players can be integrated. By simplifying different mechanisms in the turn-based board game into the card playing process based on different types of cards, the number of user interface elements that need to be displayed on the battle interface can be reduced, and the operations for the current game player object can be further simplified, thereby improving the human-computer interaction efficiency for the current game player object. On the other hand, compared with three-dimensional pieces, two-dimensional cards are inherently capable of carrying more textual information and icon information, whereas three-dimensional pieces can only carry limited textual information. Thus, compared with three-dimensional pieces in traditional preparation phases, two-dimensional cards can increase the amount of information carried within the limited display area on small-screen terminals, thereby improving the information conveying efficiency.

The cards described above can be played during the preparation phase, and some cards can be played during the battle phase, such as particular equipment cards, and effect cards of immediately drawing 2 more cards.

A card is acquired as follows:

The current game player object acquires at least one card when an acquisition condition is met. The acquisition condition includes at least one of the following acquisition conditions:

Acquisition Condition 1: A new round of turn-based combat is started. Each time a new round of turn-based combat is started, a plurality of cards are obtained. For example, 4 cards are drawn in the first round of turn-based combat, and 2 cards are drawn in subsequent rounds of turn-based combat. Acquisition Condition 2: A preset piece card is used. The preset piece card refers to a piece card that has an additional skill such as drawing, adding, or copying cards. For example, when a piece card with the same name as a piece on the board is played, an additional effect card is acquired. Acquisition Condition 3: A preset effect card is used. The preset effect card refers to an effect card that has an action effect such as drawing, adding, or copying cards. Acquisition Condition 4: A preset player card is used. The preset player card refers to an effect card that has an action effect such as drawing, adding, or copying cards. Acquisition Condition 5: The resources possessed by the current player are consumed for trading. For example, energy is consumed to draw or trade cards. Acquisition Condition 6: The player level of the player virtual character is raised. After the player level is raised, access to cards of higher quality or a greater number of cards may be unlocked. Acquisition Condition 7: The card pool is leveled up. After the card pool is leveled up, access to cards of higher quality or a greater number of cards may be unlocked. Acquisition Condition 8: A card purchase operation is performed. Acquisition Condition 9: A preset player skill is triggered. The preset player skill refers to a passive skill that has an action effect such as drawing, adding, or copying cards. The above acquisition conditions may be in combination. The acquisition conditions for different types of cards may be completely different, completely the same, or partially the same and partially different.

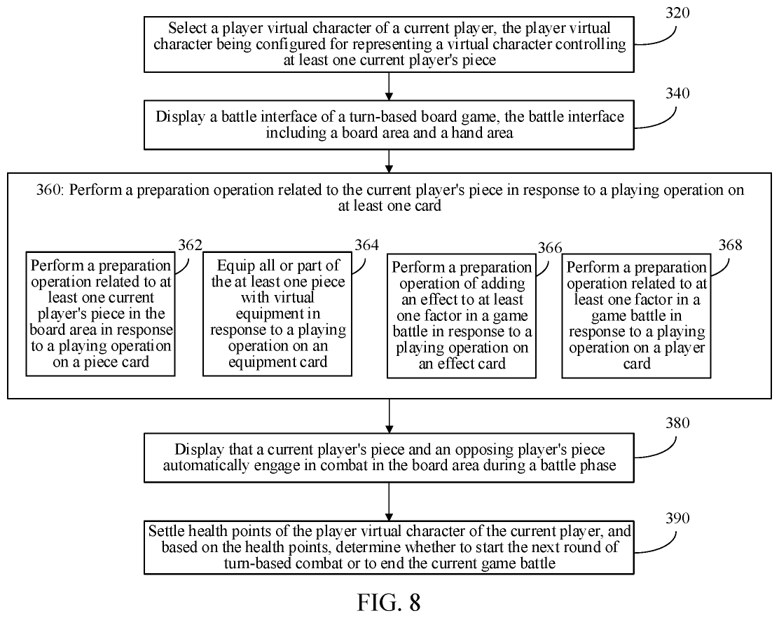

FIG. 8 illustrates a flowchart of a battle interaction method for a turn-based board game provided by an exemplary embodiment of this application. The method is performed by a computing device. In this embodiment, an example in which the method is performed by a terminal is used for description. The method includes the following operations:

### Player Selection Phase

Operation 320: Select a player virtual character of the current player, the player virtual character being configured for representing a virtual character controlling at least one current player's piece.

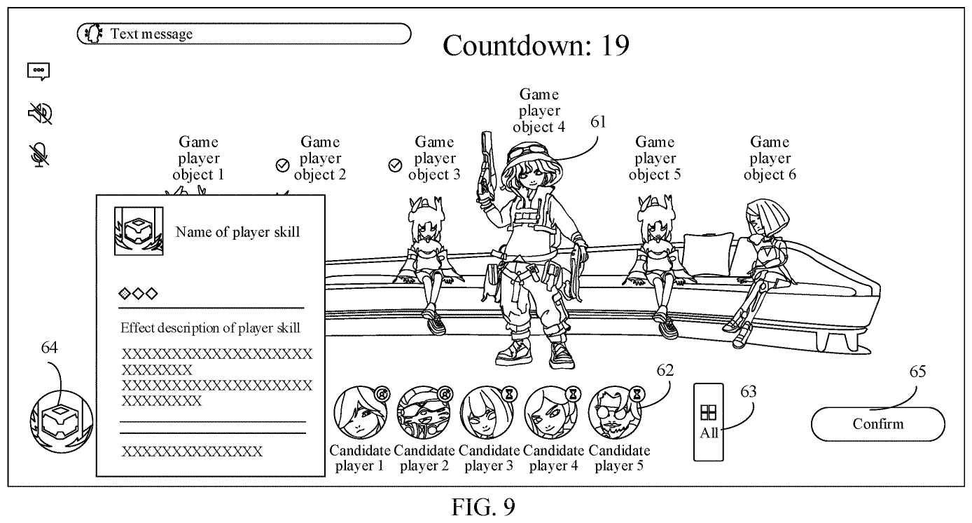

Before starting a game battle each time, the current game player character selects the desired player virtual character. Different player virtual characters have different player skills. A player skill is usually related to acquiring a player card, but may alternatively be related to other game factors. In some embodiments, for different player skills, there are some respective passive trigger mechanisms to enable the current game player character to obtain some cards with special effects. For example, the skill effect of a player is that one treasure player card is obtained each time three piece cards are played. The effect of the treasure player card is that 1 point of energy is consumed, and the level of a current player's piece in the board area is specified to be increased by 2. For example, as shown in FIG. 9, before a game battle is started, a player selection interface is displayed. The player selection interface displays player virtual characters selected by 6 game player objects. In one embodiment, the player virtual character 61 selected by the current game player object is highlighted. Taking as an example that the current game player object is game player object 4, the player virtual character selected by the game player object 4 is highlighted in a manner of standing, magnifying, and centered foreground, and the player virtual characters selected by other game player objects are conventionally displayed in a manner of sitting, a normal size, and being distributed on two sides.

The player selection interface displays a plurality of candidate player virtual characters 62, for example, candidate players 1 to 5. By swiping left or right, other candidate players may be viewed, or an “All” button 63 may be clicked/tapped on to view all candidate players. The player selection interface further displays a player skill button 64. In response to the player skill button 64 being clicked/tapped on, the name and effect description of the player skill of the currently selected player virtual character can be viewed in a pop-up window on the right. In one embodiment, messages transmitted by other game players, as well as a countdown for selecting a player or entering the battle, are displayed at the top of the player selection interface. On the left side of the player selection interface, a button for transmitting text messages, a speaker off/on button, and a microphone off/on button are displayed. After the player virtual character selected by the current game player object is determined, a “Confirm” button 65 may be clicked/tapped on to enter a ready state. The n game player objects participating in a game battle engage in turn-based combat in pairs. Each turn includes a preparation phase and a battle phase. Each turn includes a preparation phase and a battle phase.

The preparation phase of each turn includes the following operations:
Operation 340: Display a battle interface of a turn-based board game, the battle interface including a board area and a card area.

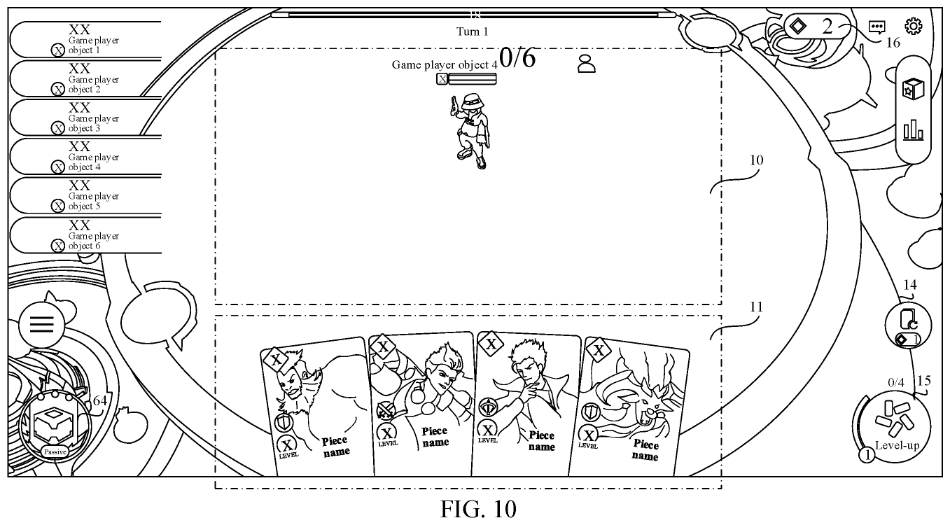

Referring to FIG. 10, the board area 10 is configured for holding at least one current player's piece and at least one opposing player's piece. In one embodiment, the upper half of the board area 10 is configured for holding the at least one opposing player's piece, and the lower half of the board area 10 is configured for holding the at least one current player's piece. The card area 11 is configured to display at least one card held by the current game player object. In an initial state or in particular situations (e.g., when all cards in the current turn have been played), the number of cards displayed in the card area 11 is 0.

In one embodiment, attribute information of the n game player objects participating in the current game battle is further displayed at the upper left corner of the battle interface. The attribute information includes at least one of a nickname, an avatar, hit points, and a player level of the game player. A player skill button 64 is displayed in the lower left corner of the battle interface. A card exchange button 14 and a level-up button 15 are further displayed in the lower right corner of the battle interface. The card exchange button 14 is configured to replace one or more cards in the card area 11. The level-up button 15 is configured to raise the level of the player virtual character, so as to unlock higher-level cards, abilities, and obtain equipment.

In one embodiment, an energy control 16 is further displayed in the upper right corner of the battle interface. The energy control 16 is configured to display the energy value possessed by the current game player object. Energy is a game resource that may be consumed in various links throughout the entire game battle.
Operation 360: Perform a preparation operation related to the current player's piece in response to a playing operation on at least one card.

The card types include at least one of the following: piece cards, equipment cards, effect cards, and player cards. The current game player object can perform preparation operations with different functions by playing different piece cards. This operation includes at least one of the following operations: Operation 362: Perform a preparation operation related to at least one current player's piece in the board area in response to a playing operation on a piece card. Operation 364: Equip all or part of the at least one piece with virtual equipment in response to a playing operation on an equipment card. Operation 366: Perform a preparation operation of adding an effect to at least one factor in a game battle in response to a playing operation on an effect card. Operation 368: Perform a preparation operation related to at least one factor in a game battle in response to a playing operation on a player card.

Since the battle conditions vary from round to round in turn-based combat, the card of each game player object is different, and the card-playing habits of each game player object differ, the number of times and the order in which the above operations 362, 364, 366, and 368 are performed in each round of turn-based combat may vary. This is not limited in this embodiment.

### Regarding Operation 362 (Piece Card):

In some embodiments, the cards in the card area include a first piece card. A first current player's piece is added to the board area in response to a playing operation on the first piece card. The first current player's piece is a piece corresponding to the first piece card. In some embodiments, the first current player's piece is a piece that has not been summoned to the board area. At least two candidate grid cells are displayed in the board area, and a first indicator element corresponding to the first piece card is displayed, in response to the playing operation on the first piece card. The first indicator element includes at least one of a scaled-down first piece card, a first current player's piece, and a first indicator arrow. The first current player's piece is added to the first candidate grid cell in response to a dragging operation of dragging the first indicator element to a first candidate grid cell, where the first candidate grid cell is one of the at least two candidate grid cells.

The at least two candidate grid cells may be all candidate grid cells, or may be candidate grid cells belonging only to the current player. The at least two candidate grid cells may always be displayed, or may be displayed only when a playing operation is recognized.

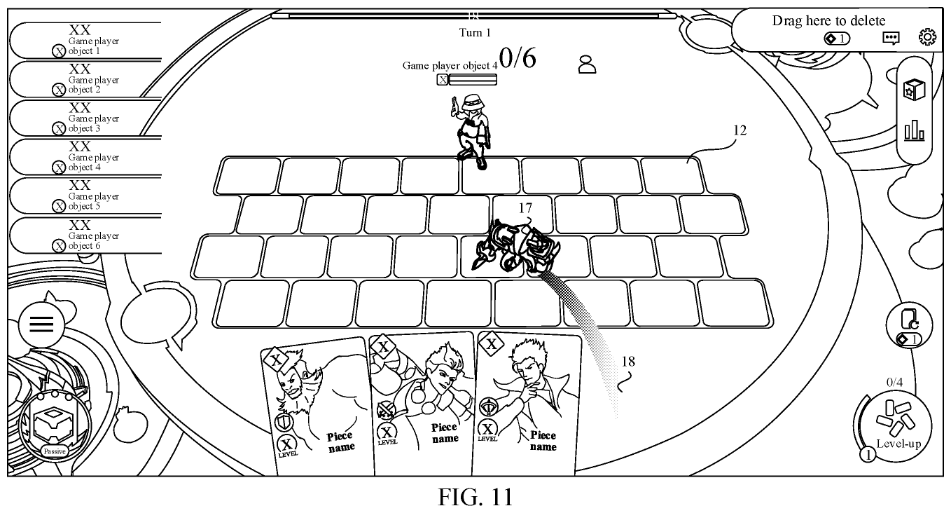

Taking as an example that the first piece card is the fourth card in FIG. 10, referring to FIG. 11, a first current player's piece 17 and a first indicator arrow 18 are displayed in response to a dragging operation on the first piece card. The first current player's piece 17 is a three-dimensional piece that slides following the real-time position of the dragging operation. The start point of the first indicator arrow 18 is the position of the first piece card before being played, and the end point thereof is the real-time position of the dragging operation. When the release position of the dragging operation is within the first candidate grid cell, the first current player's piece 17 is summoned to the first candidate grid cell. As shown in FIG. 11, in this interaction manner, the piece preparation area is eliminated, and the card area simultaneously serves both piece acquisition and preparation functions, thereby enabling a plurality of functions to share one display area and improving the human-computer interaction efficiency.

In some embodiments, the cards in the card area include a second piece card. The piece level of a second current player's piece is raised in the board area in response to a playing operation on the second piece card and the second current player's piece being already present in the board area. The second current player's piece is a piece corresponding to the second piece card. The playing operation on the second piece card may be a dragging operation. However, since the second current player's piece is already present in the board area, the release position of the dragging operation may be anywhere in the board area for the operation to be completed, and it may take effect without requiring the current game player object to precisely drag it onto the second current player's piece.

### Regarding Operation 364 (Equipment Card):

In some embodiments, the cards in the card area include an equipment card. A second indicator element corresponding to the equipment card is displayed in response to a playing operation on the equipment card. The second indicator element includes at least one of a scaled-down equipment card, virtual equipment corresponding to the equipment card, and a second indicator arrow.

The second current player's piece is equipped with the virtual equipment in response to a dragging operation of dragging the second indicator element onto the second current player's piece.

The second current player's piece is a current player's piece already present in the board area.

### Regarding Operation 366 (Effect Card):

In some embodiments, the cards in the card area include an effect card. An effect is added to at least one current player's piece, and/or an effect is added to the card acquisition process, in response to a playing operation on the effect card.

According to the target of the effect, effect cards are divided into two types: type 1: adding an effect to a current player's piece within the board area; and type 2: adding an effect to the card acquisition process. In response to a playing operation on an effect card of type 1, an effect is added to at least one current player's piece. For example, a piece type specific buff is added, or a combined buff is added when at least two pieces of the same faction are present on the board. In response to a playing operation on an effect card of type 2, an effect is applied to the card acquisition process. For example, two identical piece cards are drawn consecutively.

### Regarding Operation 368 (Player Card):

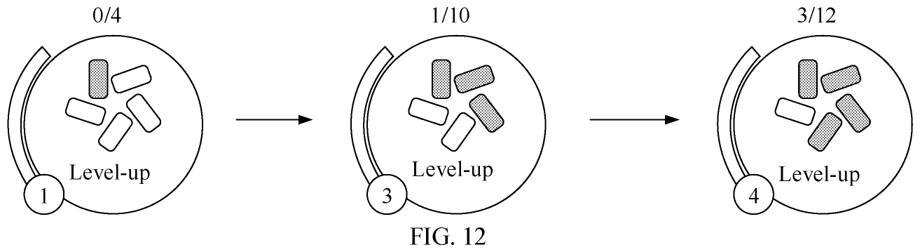

At least one of the following preparation operations is performed in response to a playing operation on the player card: adding a current player's piece, removing a current player's piece, leveling up a current player's piece, adding an effect to a current player's piece, and equipping a current player's piece with a prop; an operation related to card acquisition, an operation related to card selling, an operation related to card exchange, an operation related to a subsequent turn, and an operation related to the health points of the current game player object. During the preparation phase, the current game player object may alternatively use at least one of a card exchange function, a card removal function, and a player level-up function. Card exchange function: During the preparation phase, the current game player object may alternatively exchange one or more cards in the card area. By clicking/tapping on the card exchange button, one or more cards are exchanged. Exchanging cards consumes energy. For example, cards can be exchanged only once per turn, and a plurality of cards can be exchanged at a time. Regardless of the number of cards exchanged, one energy point is consumed. Card removal function: During the card playing process, dragging a card to a designated position allows the card to be removed or sold. The resources consumed by the removed card cannot be recovered, or may be partially recovered, or a fixed amount of energy may be recovered. The current game player object gains a particular amount of energy per turn. Any energy not used in the current turn can be carried over to the next turn. Energy can be used to raise the player level. The higher the player level, the higher the quality of the card that can be drawn per turn. Meanwhile, new capabilities such as talents or purchasable equipment may be unlocked. In one embodiment, the level-up button 15 may display quality indicators of different colors. As the player level is raised, the quality indicator corresponding to the current player level may be lit up. The quality indicator may be, for example, a small circular rectangle as shown in FIG. 12, or may be in other shapes or forms. For example, when the current game player object is at player level 1, 2, 3, 4, or 5, cards of quality 1, 2, 3, 4, or 5 may be unlocked respectively.

The battle phase of each turn includes the following operations:
Operation 380: Display that the current player's piece and the opposing player's piece automatically engage in combat in the board area during the battle phase.

The automatic combat process between the current player's piece and the opposing player's piece in the board area does not require manual control by the current game player object. Instead, the client or server automatically controls the combat between the pieces on both sides based on factors such as the grid cell positions of the pieces on both sides on the board, piece attributes, piece levels, piece skills, piece attributes, and combined enhancement attributes between pieces, until the pieces on one side are knocked out.

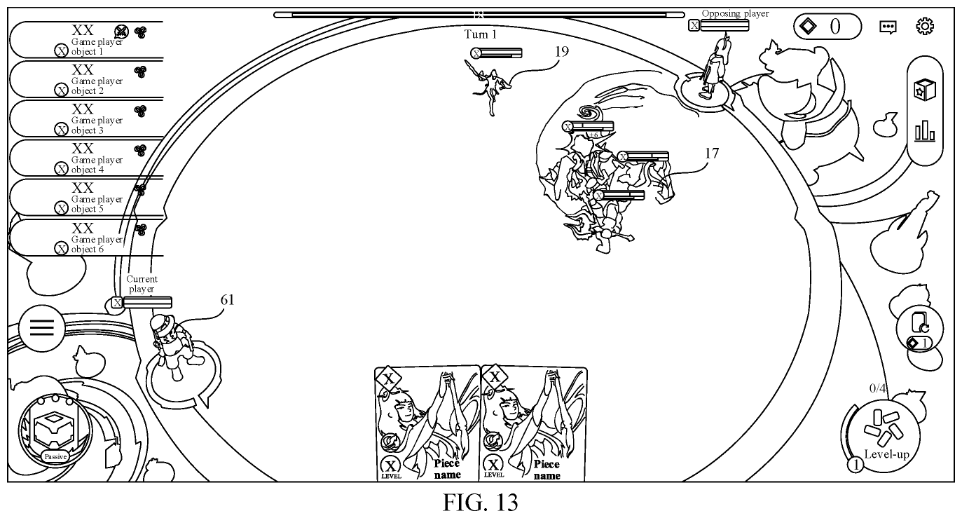

FIG. 13 illustrates a schematic diagram of automatic combat between a current player's piece 17 and an opposing player's piece 19 in the board area. None of the actions such as movement, skill casting, and functions of pieces on both sides during the combat process need to be manually controlled by game players.

A combat settlement phase includes the following operation:
Operation 390: Settle health points of the player virtual character of the current player, and based on the health points, determine whether to start the next round of turn-based combat or to end the current game battle.

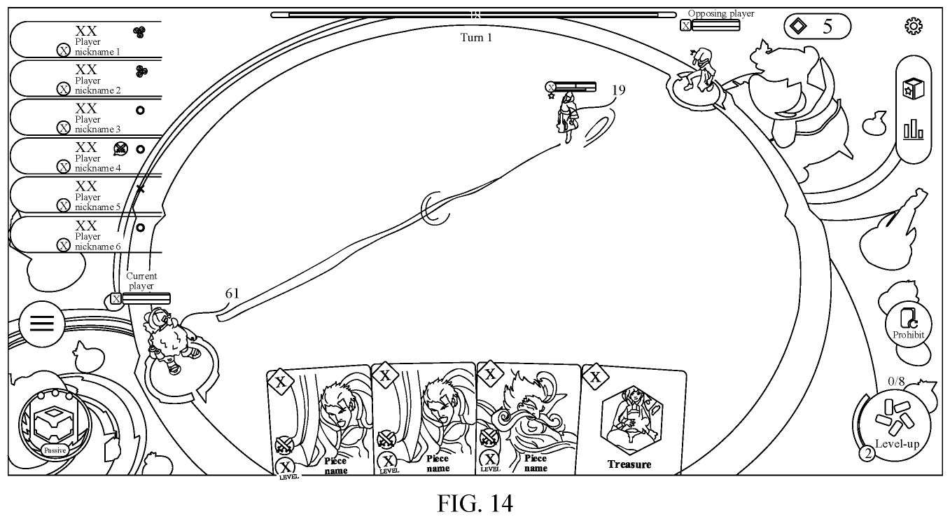

Both the current game player object and the opposing game player object have health points. After the current turn ends, the health points of the game player object on the losing side will be deducted by a particular amount. The particular amount may be determined based on the number of remaining pieces on the winning side, or may be a fixed value. This is not limited in this embodiment. When the health points are reduced to zero, the game player object is eliminated from the current game battle. If the health points have not been reduced to zero, the game proceeds to the next round of turn-based combat within the current game battle, and the game player object continues to battle against one of the n game player objects until it is eliminated, or until it becomes the last remaining non-eliminated side and wins the current game battle. In some embodiments, the settled damage is determined based on the number of remaining pieces on the winning side on the board. FIG. 14 illustrates that an animation effect for settling the health points of the player virtual character 61 of the current player when the current player is the loser and one opposing player's piece 19 remains. A health point progress bar may be displayed above the head of the player virtual character 61.

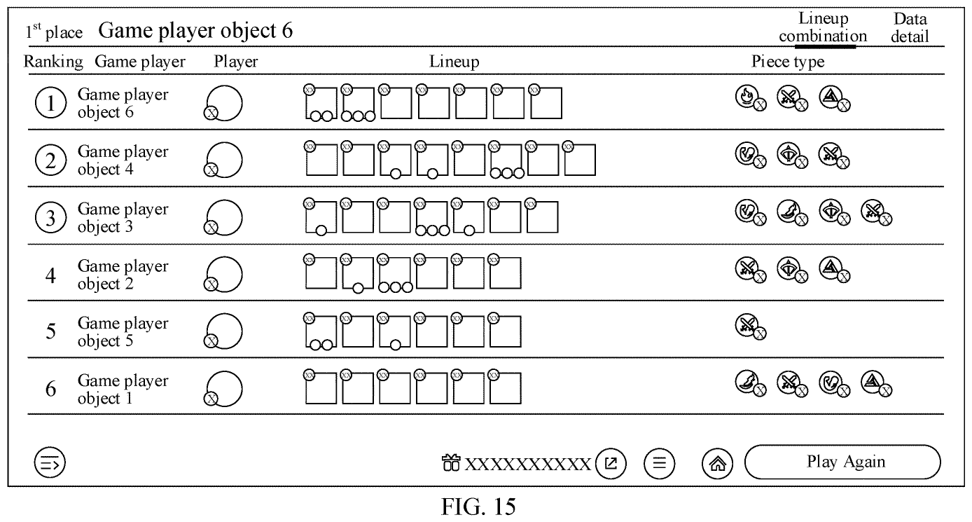

For example, referring to FIG. 15, settlement information of the current game battle is displayed on a settlement interface. The settlement information includes information such as game player rankings, and the player, the lineup, and the piece type used by each game player.

According to the method provided in this embodiment, with piece cards, the virtual store in traditional auto chess can be eliminated based on the playstyle characteristics of the cards. The cumbersome process in which users previously needed to purchase their desired pieces from dozens of available pieces in the store is replaced with a process in which the game system automatically deals a few cards to the game player. This eliminates the need for users to manually select cards themselves, thereby reducing the number of interactive operations required for users to acquire pieces, as well as the amount of information that users need to process.

According to the method provided in this embodiment, with the effect cards, the effect buttons or controls in traditional auto battlers can be eliminated. With the equipment cards, the neutral creep round in traditional auto battlers can be eliminated. With the player cards, gameplay characteristics related to players can be integrated. By simplifying different mechanisms in the turn-based board game into the card playing process based on different types of cards, the number of user interface elements that need to be displayed on the battle interface can be reduced, and the time required for the user to actively locate the relevant function entry is reduced. Besides, the operations for the current game player object can further be simplified, thereby improving the human-computer interaction efficiency for the current game player object.

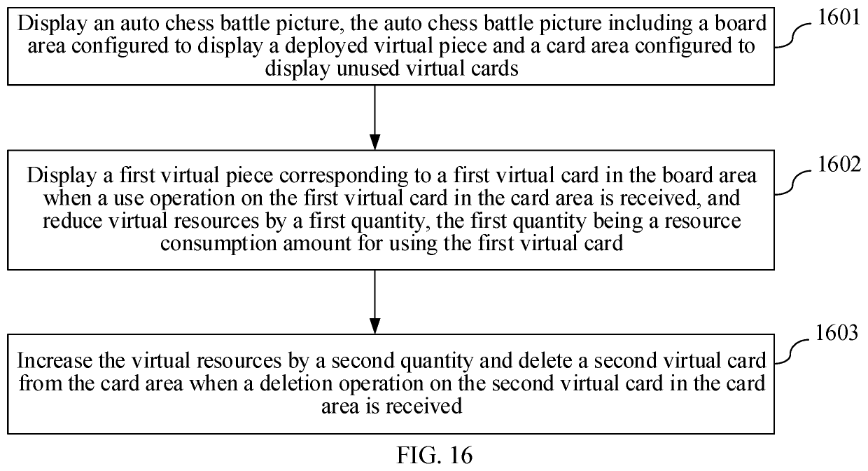

FIG. 16 illustrates a flowchart of a method for updating resources in an auto chess provided by an exemplary embodiment of this application. The method is performed by a computing device, and includes the following operations:
Operation 1601: Display an auto chess battle picture, the auto chess battle picture including a board area configured to display a deployed virtual piece and a card area configured to display unused virtual cards.

In some embodiments, a virtual piece is a character piece that can move and implement an attack behavior during the combat process of an auto chess battle. When the board area is a two-dimensional board, the virtual piece is also a two-dimensional piece, displayed as a two-dimensional icon or a two-dimensional representation. When the board area is a three-dimensional board, the virtual piece is also a three-dimensional piece, displayed as a three-dimensional model or a three-dimensional representation.

In some embodiments, virtual cards are randomly allocated by a terminal at the beginning of a battle round and are configured to exchange for virtual pieces. A virtual card is displayed in the card form, and the display information of the virtual card may include a name, an icon, a quantity of virtual resources consumed when played, and a card description. In some embodiments, the board area is configured to display the arrangement position of a current player's deployed piece in the auto chess battle picture. The board area has a plurality of grid cells configured to the initial position of the virtual piece before the start of a battle round.

In some embodiments, the card area is configured to display unused virtual cards. Virtual cards in the card area may be configured to redeem virtual pieces, virtual equipment, virtual effects, etc. The specific redeemable item may be determined based on the card type and the card identifier of the virtual card. Virtual cards may alternatively be exchanged for virtual resources via a deletion operation, and these virtual resources may be configured to exchange for virtual cards.

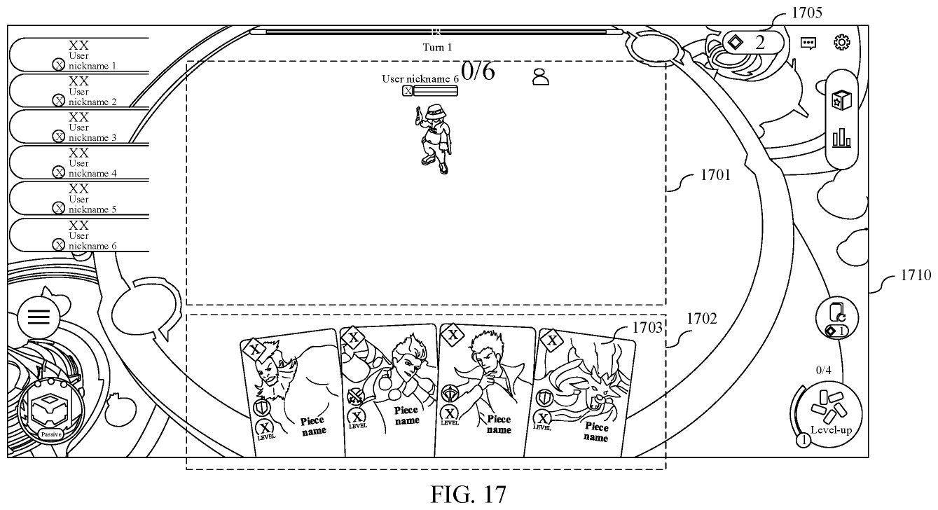

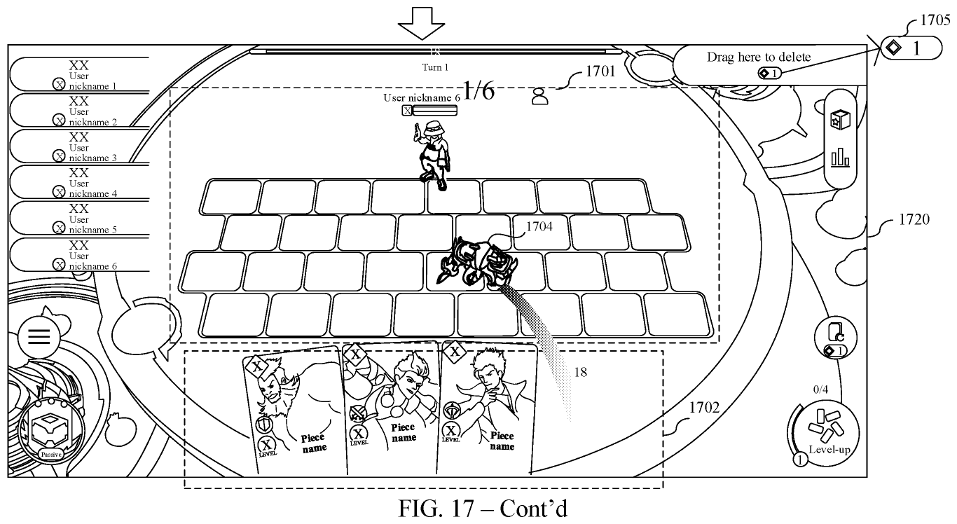

For example, as shown in FIG. 17, an auto chess battle picture 1710 includes a board area 1701 and a card area 1702. The board area 1701 has no virtual piece deployed thereon, and the card area 1702 has an unused virtual card 1703. In the auto chess battle picture 1720, the virtual card 1703 is used, and then the board area 1701 displays the deployed virtual piece 1704.
Operation 1602: In response to a use operation on a first virtual card in the card area, display a first virtual piece corresponding to the first virtual card in the board area and reduce virtual resources by a first quantity, the first quantity being a resource consumption amount for using the first virtual card.

In some embodiments, the use operation on a virtual card may be a moving operation. For instance, the virtual card is changed into a corresponding virtual piece in response to the operation of moving the virtual card to the board area. The use operation may alternatively be a selection operation. For instance, a virtual card is selected first, and then a first placement position on the board area is selected, thereby determining the placement position of the virtual piece corresponding to the virtual card. In addition, it may be another use operation of obtaining a virtual piece by using a virtual card. This is not described redundantly in this embodiment of this application.

In some embodiments, virtual cards have a plurality of card types. In one embodiment, the card types of the virtual cards include a piece type, an equipment type, an effect type, etc. Among them, piece cards are configured to exchange for corresponding virtual pieces. The process of exchanging a piece card for a virtual piece requires consuming a particular quantity of virtual resources. The resource consumption amount of virtual resources is determined according to the virtual card.

In one embodiment, after virtual resources are consumed to redeem a piece card and obtain a corresponding virtual piece, the virtual piece cannot be reverted back to the piece card. To be specific, a used virtual card cannot return to the card area for reuse. Alternatively, after virtual resources are consumed to redeem a piece card and obtain a corresponding virtual piece, the virtual piece can be reverted back to the piece card. Alternatively, after virtual resources are consumed to redeem a piece card and obtain a corresponding virtual piece, the virtual piece may be sold to obtain the virtual resources, whereby the piece card can be obtained. This is not limited here.

In some embodiments, the first virtual piece corresponding to the first virtual card is displayed in the board area when the use operation on the first virtual card in the card area is received and the first virtual card is a piece card.

The piece card is a card configured to adjust the virtual piece in the board area. After being used, the first virtual card is deleted from the card area.

In one embodiment, the piece card is a card that is converted into a virtual piece in the board area. For example, when the used virtual card is a piece card, the piece card is converted into and displayed as a virtual piece in the board area. Alternatively, the piece card is a card configured to level up a virtual piece in the board area. For instance, if a piece card corresponds to a virtual piece A and the virtual piece A is present on the board area, the virtual piece A on the board area may be leveled up based on the process of using the piece card. For instance, if the original piece level is 2, the piece level of the virtual piece A is raised to level 3 by using the piece card once. This is not limited here.

When the virtual card is a piece card, the virtual card displays at least one of the following information: a piece representation, a piece name, an energy value consumed when playing the virtual card, a piece type or faction to which the piece belongs, a level to which the piece is raised after playing the card, an additional effect description of the piece, etc.

For example, the piece card is one type of virtual card. The piece card serves as the condition for converting the first virtual card into the first virtual piece or for leveling up the first virtual piece. Thus, the first virtual piece is displayed when the first virtual card is a piece card. In this case, the used first virtual card is deleted from the card area based on the process of using the first virtual card in the card area, so as to prevent invalid reuse process of the first virtual card.

The above describes displaying the first virtual piece in the board area based on the type of the first virtual card. The conditional conversion between virtual cards and virtual pieces enhances game player interactivity, giving game players a sense of authenticity while experiencing dynamic changes in the game. It also allows game players to adjust the state of virtual pieces through strategic choices, increasing the strategic depth of the game and encouraging game players to think about how to maximize the use of the virtual cards in their hands. In addition, the process of deleting the used virtual cards from the card area helps game players manage card resources in their hands, effectively avoids the problem of invalid virtual cards remaining redundant in the card area, ensures game fairness and interface cleanliness, and reduces rendering resource consumption.

In some embodiments, the first virtual card refers to an unused virtual card in the card area that is selected by the use operation. In one embodiment, there may be one or more first virtual cards. To be specific, the use operation may use a single virtual card to obtain the corresponding single virtual piece, or simultaneously use a plurality of virtual cards to obtain the virtual pieces corresponding to the virtual cards. After the first virtual card is used, the terminal deletes the first virtual card from the card area and displays the first virtual piece in the board area.

In some embodiments, virtual resources are configured to redeem a virtual card. For example, the virtual resources may be energy, coins, or other forms of virtual resources. When the first virtual card is a piece card, the virtual resources are configured to convert the first virtual card into the first virtual piece. A virtual card corresponds to a determined resource consumption amount that is configured for representing the quantity of virtual resources consumed for using the virtual card. Different virtual cards correspond to different resource consumption amounts. Virtual resources are consumed when a virtual card is used, but are not consumed during the process of acquiring the virtual card.

For example, as shown in FIG. 17, in the auto chess battle picture 1710, the first virtual card 1703 is an unused piece card in the card area 1702, and the quantity of virtual resources 1705 is 2. When the use operation on the first virtual card 1703 in the card area 1702 is received, as shown in the auto chess battle picture 1720, the terminal displays the first virtual piece 1704 in the board area 1701. The quantity of virtual resources 1705 becomes 1, meaning the resource consumption amount of virtual resources 1705 is 1 (i.e., the first quantity is 1), and the first virtual card 1703 in the card area 1702 disappears.
Operation 1603: In response to a deletion operation on a second virtual card in the card area, increase the virtual resources by a second quantity and delete the second virtual card from the card area, the second quantity being greater than the first quantity.

In some embodiments, the second virtual card is located in the card area. In one embodiment, the deletion operation on the second virtual card may be a moving operation, such as moving the virtual card to a deletion area, or a selection operation, such as selecting the second virtual card and clicking/tapping on a delete button. This is not described redundantly in the embodiments of this application.

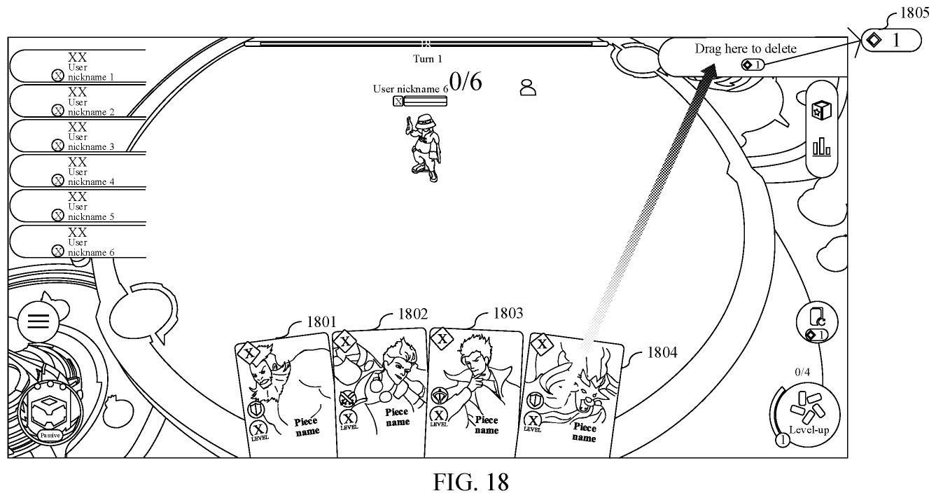

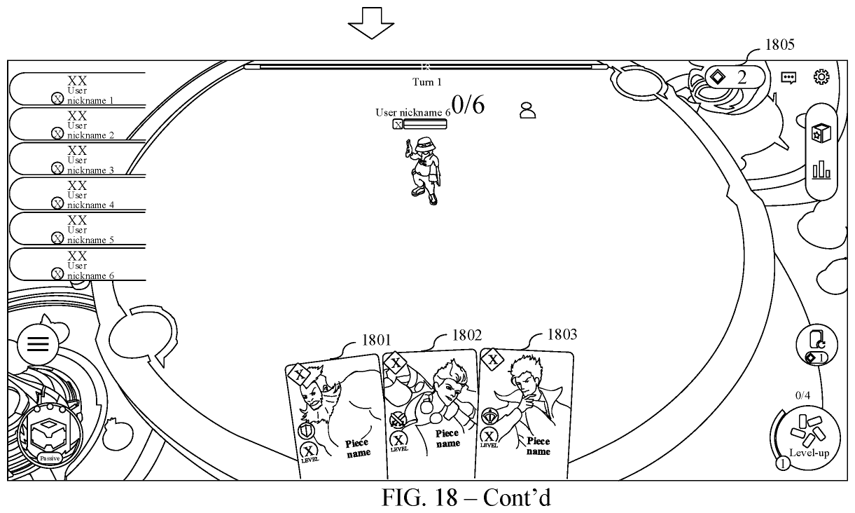

In an exemplary example, as shown in FIG. 18, virtual cards 1801, 1802, and 1803, and a second virtual card 1804 are present in the card area. The terminal receives an operation of moving the second virtual card 1804 to the deletion area. Subsequently, the quantity of virtual resources 1805 changes from 1 to 2, with a resource increment of 1. The remaining virtual cards in the card area are virtual cards 1801, 1802, and 1803.

Deleting different virtual cards corresponds to the same first resource increment.

For example, different virtual cards in the card area may be different in quality. The fact that deleting different virtual cards corresponds to the same first resource increment means that deleting a high-quality virtual card gives the same first resource increment as deleting a low-quality virtual card. For example, a virtual card that costs 1 (with the resource consumption amount of 1 when used) and a virtual card that costs 2 both provide an energy value of 1 when deleted.

Unlike a virtual piece deployed on the board area, virtual cards are dealt by the system and have not been deployed on the board area. Game players can convert virtual cards into virtual pieces, or delete virtual cards to redeem them for the fixed second quantity of virtual resources. Due to the static nature of virtual cards, the randomness of cards in the game can be reduced by setting that different virtual cards correspond to the same first resource increment, thereby ensuring predictability in the process of exchanging virtual cards for resources by game players. This helps game players make more careful plans based on current card combinations and needs, avoids the problem that dealt virtual cards cannot be effectively used by game players, and also helps balance the value of different types of virtual cards, thereby improving game fairness.

Operation 1603 may be performed before step 1602. An execution sequence of step 1602 and step 1603 is not limited in this embodiment of this application.

In conclusion, according to the method provided in this embodiment, with piece cards, the virtual store in traditional auto chess can be eliminated based on the playstyle characteristics of the cards. The cumbersome process in which users previously needed to purchase their desired pieces from dozens of available pieces in the store is replaced with a process in which the game system automatically deals a few cards to the game player. This eliminates the need for users to manually select cards themselves, thereby reducing the number of interactive operations required for users to acquire pieces, as well as the amount of information that users need to process.

According to the method provided in this embodiment, the virtual resources may alternatively be acquired by deleting the virtual cards, thereby enriching the ways to acquire the virtual resources and enriching strategies for auto chess games. Moreover, when a virtual card is deleted, the virtual resources are increased by a fixed quantity. This eliminates the need to calculate the quantity of resources increased or reduced according to the quality of the virtual cards, facilitating users in quickly implementing the virtual resource calculation process and hence effectively performing relevant decisions. Thus, the human-computer interaction efficiency is further improved.

In one embodiment, in addition to obtaining virtual resources by deleting virtual cards, the terminal may obtain virtual resources by deleting virtual pieces. In some embodiments, when receiving the deletion operation on the first virtual piece in the board area, the terminal increases the virtual resources by a third quantity and deletes the first virtual piece from the board area, where deleting different virtual pieces corresponds to the same second resource increment, and deleting virtual pieces at different levels corresponds to the same second resource increment; and the second resource increment is the third quantity.

In an embodiment of this application, a level is configured for representing the quality of a virtual piece. The higher the level, the higher the quality of the virtual piece; and the lower the level, the lower the quality of the virtual piece. Deleting virtual pieces at different levels corresponds to the same second resource increment. To be specific, deleting a high-level virtual piece gives the same second resource increment as deleting a low-level virtual piece.

In the foregoing embodiments, when a virtual piece is deleted, the virtual resources are increased by a fixed quantity, so that game players and even the computing device do not need to additionally calculate the quantity of virtual resources increased or reduced according to the quality of the virtual piece. This facilitates a quick calculation process of virtual resources, helps enhance the rhythm of the game, reduces redundant virtual pieces on the virtual board, and gives full play to the utility of virtual pieces being exchangeable for virtual resources while improving the visual simplicity of the virtual board. In addition, the process of deleting virtual pieces and exchanging them for virtual resources can increase changes and dynamic effects during a battle, improve the flexible challenge of a game battle, better ensure game fairness, and encourage game players to adjust tactics flexibly, thereby greatly enhancing game strategy. This also helps increase the strategic depth of the game through a proper resource management mechanism. Thus, the human-computer interaction efficiency is improved.

The first resource increment obtained by deleting a virtual card in the card area may be the same as or different from the second resource increment obtained by deleting a virtual piece in the board area. To be specific, the third quantity corresponding to the first resource increment may be the same as or different from the third quantity corresponding to the second resource increment. This is not limited here.

In one embodiment, when the deletion operation on the first virtual piece in the board area is received, the terminal may perform the following sub-operations.
Sub-operation 1: Display first deletion prompt information when the deletion operation on the first virtual piece in the board area is received and a piece level of the first virtual piece is higher than a level threshold.

The first deletion prompt information is information configured for prompting that the first virtual piece is to be deleted. The game player may be more intuitively prompted by using the first deletion prompt information to perform a confirmation operation on the deletion process of the first virtual piece.

In an implementation, when the terminal receives the deletion operation on the first virtual piece in the board area and the piece level of the first virtual piece is higher than the level threshold, the terminal displays a first deletion prompt information box. The first deletion prompt information box includes “Confirm” and “Cancel” options.

When the piece level of the first virtual piece is lower than or equal to the level threshold, the quality of the virtual piece is low, losses caused by deleting the virtual piece are small, and the terminal does not need to display a deletion confirmation prompt.
Sub-operation 2: Increase, in response to a confirmation operation on the first deletion prompt information, the virtual resources by the third quantity, and delete the first virtual piece from the board area.

In an implementation, when the countdown for displaying the first deletion prompt information box expires, the terminal automatically performs the confirmation operation, and subsequently, in response to the confirmation operation on the first deletion prompt information, increases the virtual resources by the third quantity and deletes the first virtual piece from the board area.

In another implementation, when receiving a triggering operation on the “Confirm” option, the terminal increases the virtual resources by the third quantity and deletes the first virtual piece from the board area.

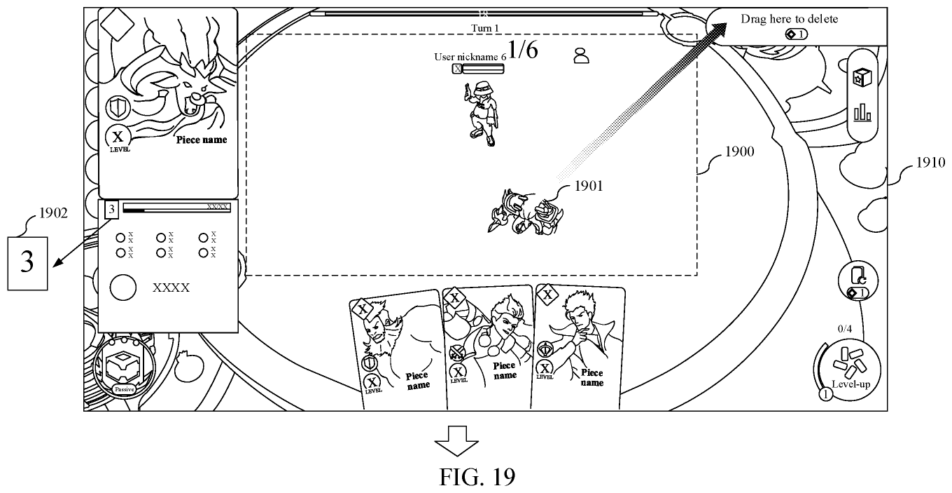

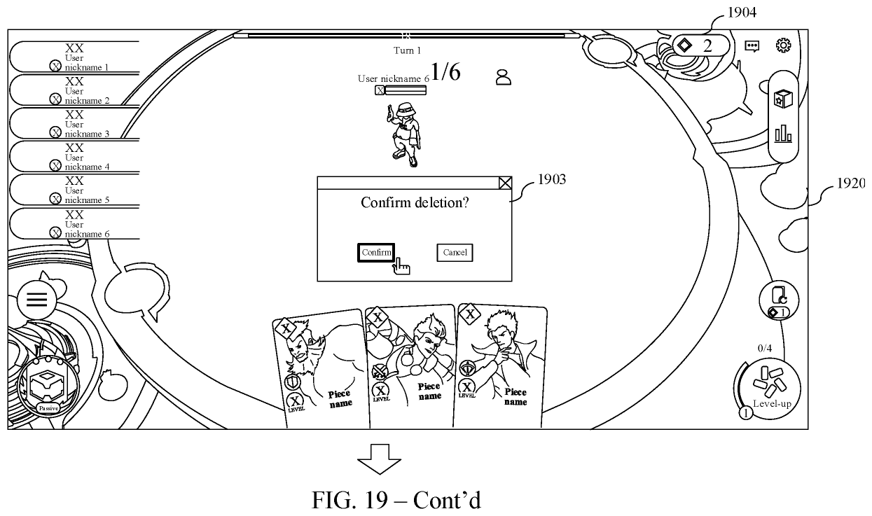

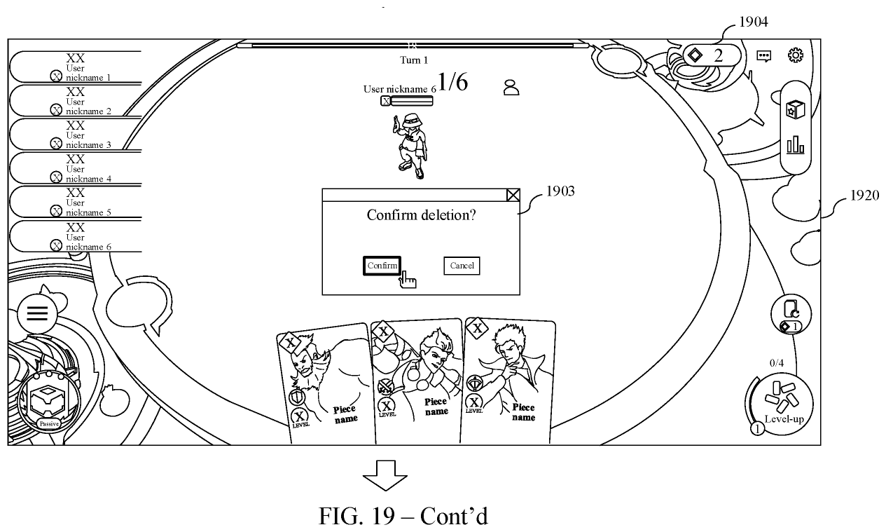

In an exemplary example, as shown in FIG. 19, there is a virtual piece 1901 in a board area 1900 in an auto chess battle picture 1910. The piece level 1902 of the virtual piece 1901 is level 3. When receiving a deletion operation of moving the virtual piece 1901 to a deletion area, the terminal determines, according to the level threshold at the background being level 2, that the piece level of the virtual piece 1901 exceeds the level threshold, and then displays first deletion prompt information 1903, as shown in an auto chess battle picture 1920. Subsequently, the terminal increases the virtual resources 1904 by one point and deletes the first virtual piece 1901 from the board area 1900 in response to the confirmation operation. As shown in an auto chess battle picture 1930, the quantity of virtual resources 1904 is 3, and there is no virtual piece 1901 in the board area 1900.

In this embodiment of this application, the terminal displays the first deletion prompt information when the piece level of the first virtual piece is higher than the level threshold. Thus, the problem that the first virtual piece is mistakenly deleted when the terminal receives a misoperation can be effectively avoided. The accuracy of deleting the first virtual piece is ensured by using the combination of the deletion operation and the confirmation operation for the first deletion prompt information. Subsequently, the terminal can increase the virtual resources by the third quantity only when performing the confirmation operation. Thus, it is ensured that the process of deleting the virtual piece conforms to the game player's intention, thereby improving the accuracy of the human-computer interaction operation.

In some embodiments, the card types of the virtual cards further include an equipment type. An equipment card is a card configured to wear virtual equipment for at least one virtual piece, so as to improve the combat capability of the virtual piece. When the terminal receives the deletion operation on the first virtual piece, the first virtual piece may carry virtual equipment, or may not carry virtual equipment.

In one embodiment, the first virtual piece may be a virtual piece carrying virtual equipment. When receiving the deletion operation on the first virtual piece in the board area, the terminal adds a third virtual card corresponding to the virtual equipment to the card area. The third virtual card is an equipment card.

In one embodiment, the third virtual card may be a virtual card that does not need to consume virtual resources again. In one embodiment, the terminal may alternatively reduce the quantity of virtual resources based on the resource consumption amount for the third virtual card when the third virtual card is used again.

The above describes that when a virtual piece is deleted, if the virtual piece is equipped with the virtual equipment, the third virtual card corresponding to the virtual equipment is redisplayed in the card area. This process enables the virtual equipment carried by the deleted virtual piece to be converted into the equipment card and put into the game interaction process again without being wasted. In this way, reusable resources in the game can be effectively recycled, so that the equipment card can be fully utilized in different scenarios, thereby improving the flexibility of resource management. In addition, this process also helps a game player flexibly match the equipment card with other virtual pieces to enhance dynamic variability of the game, improve the strategic depth of the game player and the sustainability of the game, so that the game system is more flexible and dynamic. Thus, the game experience is enriched, and the human-computer interaction efficiency is improved.

In some embodiments, some important virtual cards may be present in the card area. To avoid deleting an important virtual card due to a misoperation, the terminal may display the deletion confirmation prompt for the deletion operation on a virtual card of a specific type. This process includes the following steps.
Operation 1: Display second deletion prompt information when the deletion operation on the second virtual card in the card area is received and the second virtual card is a first-type virtual card.

The second deletion prompt information is information configured for prompting that the second virtual card is to be deleted. The game player may be more intuitively prompted by using the second deletion prompt information to perform the confirmation operation on the deletion process of the second virtual piece.

In some embodiments, the first-type virtual card is a virtual card that cannot be acquired via card dealing, drawing, and exchanging operations, or a virtual card that is rare due to a low acquisition rate. The first-type virtual card may include at least one of an equipment card, a player card, and an effect card.

In an implementation, when the terminal receives the deletion operation on the second virtual card in the card area and the second virtual card is a first-type virtual card, the terminal displays a second deletion prompt information box. The second deletion prompt information box includes “Confirm” and “Deny” options.
Operation 2: Increase, in response to a confirmation operation on the second deletion prompt information, the virtual resources by the second quantity, and delete the second virtual card from the card area.

In an implementation, when the countdown for displaying the second deletion prompt information box expires, the terminal automatically triggers the confirmation operation, and subsequently, in response to the confirmation operation on the second deletion prompt information, increases the virtual resources by the second quantity and deletes the second virtual card from the card area.

In another implementation, when receiving a triggering operation on the “Confirm” option, the terminal increases the virtual resources by the second quantity and deletes the second virtual card from the card area.

In one embodiment, the resource increment obtained by deleting a first-type virtual card from the card area may be the same as or different from that obtained by deleting other virtual cards from the card area. This increment may be referred to as, for example, the first resource increment. The first resource increment is the second quantity. The embodiments of this application do not limit this.

In the foregoing embodiments, when receiving the deletion operation on the first-type virtual card, the terminal displays the second deletion prompt information. The first-type virtual card is used as a constraint for displaying the second deletion prompt information. This avoids the problem of mistakenly deleting the first-type virtual card. By combining the deletion operation with the confirmation operation on the second deletion prompt information, the accuracy of the deletion operation is improved. Thus, it is ensured that the deletion operation conforms to the game player's intention, thereby improving the accuracy of the human-computer interaction operation.

In some embodiments, after the terminal receives the deletion operation of deleting the second virtual card from the card area, there may still be a fourth virtual card in the card area that is identical to the second virtual card. The terminal may determine the game player's intention according to the deletion operation on the second virtual card. When it is determined that the fourth virtual card that is identical to the second virtual card is not needed, the fourth virtual card is deleted in batch. This process may specifically include the following operations.
Operation 1: Display batch deletion prompt information when a fourth virtual card that is the same as the second virtual card is present in the card area.

In some embodiments, the fourth virtual card refers to a piece card that is identical to the second virtual card. In one embodiment, there may be one or more fourth virtual cards, and the fourth virtual card includes no second virtual card.

In an implementation, when the terminal receives the deletion operation of deleting the second virtual card and the fourth virtual card that is identical to the second virtual card is present in the card area, the terminal displays a batch deletion prompt information box. The batch deletion prompt information box includes “Confirm” and “Deny” options. For instance, the terminal displays a prompt box containing a prompt text “Confirm batch deletion of the selected cards?” along with “Yes” and “No” option buttons.

In one embodiment, the fourth virtual card may alternatively be other types of virtual cards. When the fourth virtual card includes a first-type virtual card, the terminal may continue to display a second deletion prompt box. For instance, the terminal displays the second deletion prompt information box that contains the prompt text “The selected cards include an important card. Confirm deletion? ” along with “Yes” and “No” option buttons.
Operation 2: Increase, in response to a confirmation operation on the batch deletion prompt information, the virtual resources by a fourth quantity, and delete the fourth virtual card from the card area, the fourth quantity being determined based on a number of the fourth virtual cards and the second quantity.

In some embodiments, since each fourth virtual card is identical to the second virtual card, deleting each fourth virtual card corresponds to the same resource increment, for example, each equals the first resource increment obtained by deleting a virtual card.

In an implementation, the terminal obtains, according to the number of fourth virtual cards and the first resource increment obtained by deleting a single fourth virtual card, a resource increment obtained by deleting all the fourth virtual cards, and then adds this resource increment to the second quantity to obtain a fourth quantity.

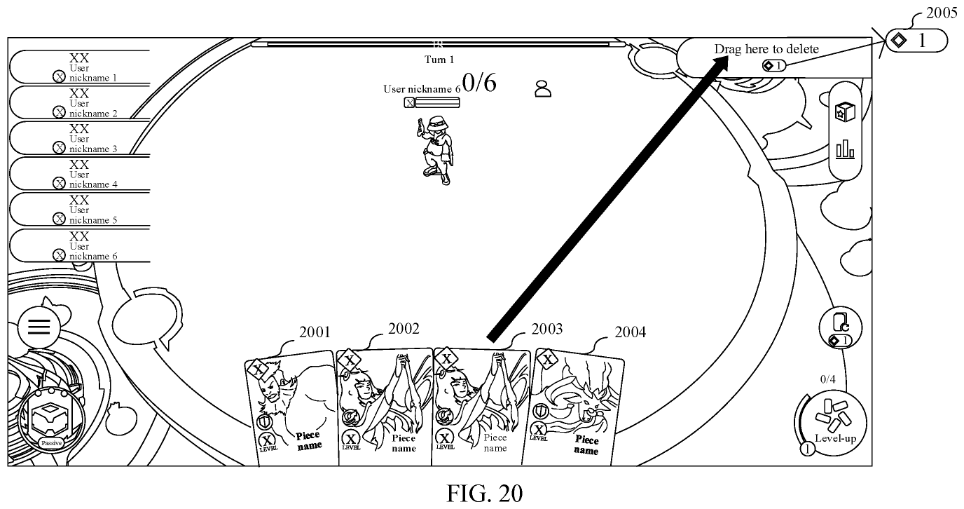

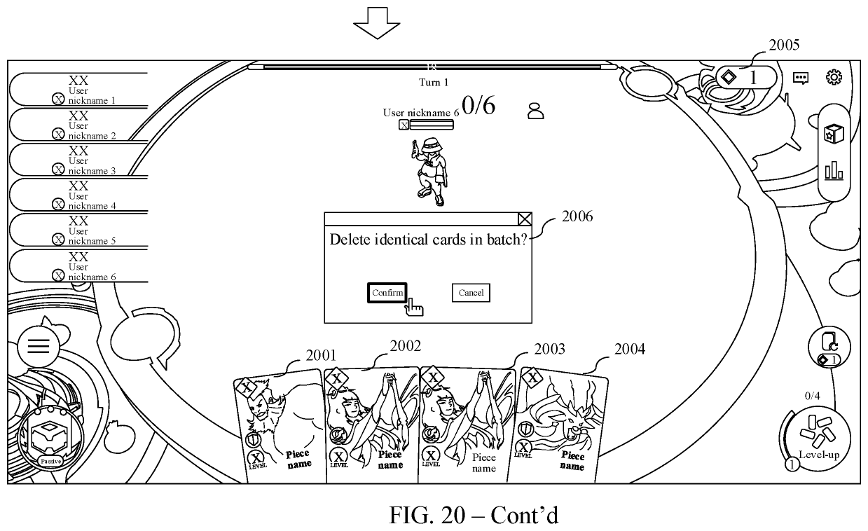

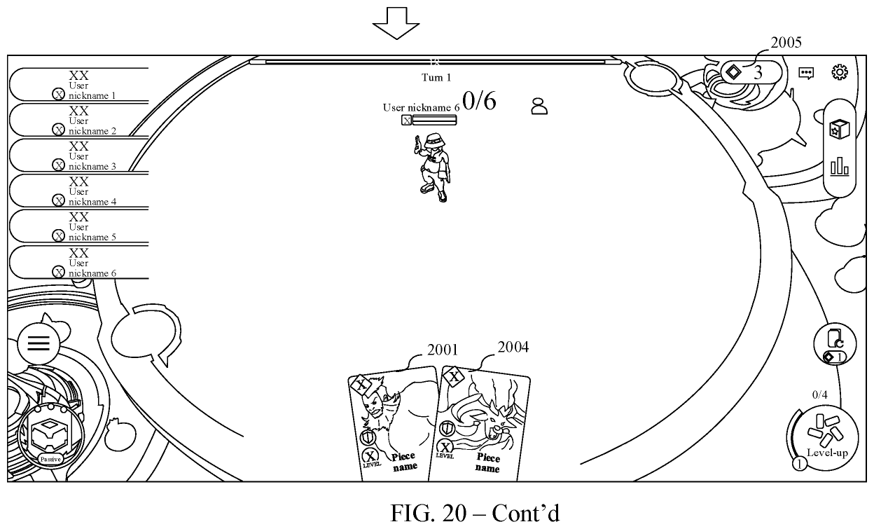

In an exemplary example, as shown in FIG. 20, virtual cards 2001, 2002, and 2003, and a second virtual card 2004 are present in the card area. The quantity of virtual resources 2005 is 1. The terminal receives an operation of moving the second virtual card 2003 to the deletion area, then determines whether there is a virtual card in the card area that is identical to the virtual card 2003, and if so, displays a batch deletion prompt 2006. The terminal determines, in response to a confirmation operation, that the virtual cards 2002 and 2003 are deleted, where the first resource increment obtained by deleting a single virtual card is 1, and the resource increment obtained by deleting two virtual cards is 2. Finally, virtual cards 2001 and 2004 remain in the card area, and the quantity of virtual resources 2005 is 3.

In some other embodiments, the terminal may enable a batch deletion operation on virtual cards by simultaneously selecting a plurality of virtual cards. In an implementation, the terminal displays, in response to a triggering operation on a batch deletion function, card options for the virtual cards in the card area. When receiving a selection operation on a plurality of virtual cards and receiving a deletion operation, the terminal deletes the selected plurality of virtual cards in batch. In one embodiment, the process of deleting a plurality of virtual cards in batch by the terminal may be a continuous operation process. For instance, when receiving a horizontal sliding selection operation immediately after receiving a long-press operation on a virtual card, the terminal determines to select and delete a plurality of virtual cards in batch.

In the foregoing embodiments, the terminal may perform the batch deletion operation on the virtual cards. When a plurality of identical virtual cards are present in the card area, the batch deletion operation enables the user to delete the plurality of identical cards at once, without having to repeat the deletion operation a plurality of times. This improves the efficiency of the deletion operation. Especially in the presence of a large number of cards, the user's time and effort can be saved, enhancing the overall user experience, and the efficiency of deleting identical virtual cards is improved. Moreover, when the user confirms the batch deletion operation, the quantity of virtual resources increased is calculated based on the number of virtual cards deleted, giving game players a stronger sense of control and decision-making power over virtual card management and resource allocation. This allows them to flexibly adjust the number of cards and the use of resources, thereby improving the human-computer interaction efficiency.

In some embodiments, the drawing process of virtual cards is random, making it difficult for game players to obtain the desired virtual cards and limiting the space for implementing the strategies of the game players. To enrich strategies in the auto chess game, the terminal may modify the number of virtual cards in the personal deck according to historical deletion operations, thereby changing the probability of drawing virtual cards and facilitating game players in drawing the desired virtual cards according to strategies.

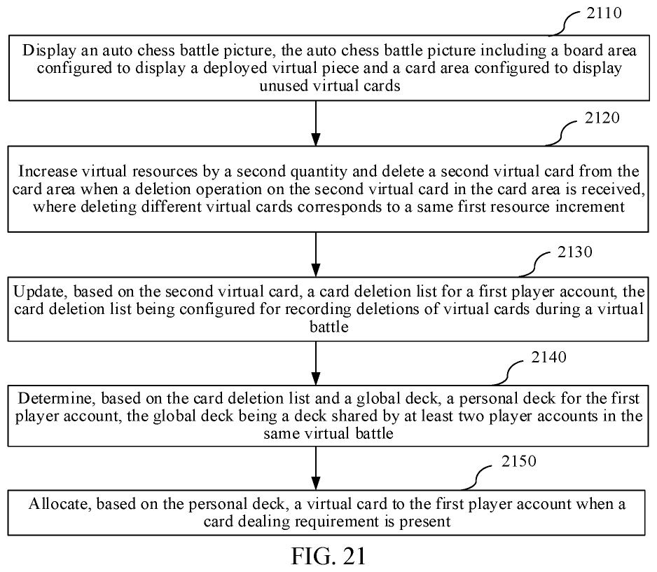

FIG. 21 illustrates a flowchart of a method for updating resources in an auto chess provided by another exemplary embodiment of this application. The method is performed by a computing device, and includes the following operations:
Operation 2110: Display an auto chess battle picture, the auto chess battle picture including a board area configured to display a deployed virtual piece and a card area configured to display unused virtual cards.
Operation 2120: Increase the virtual resources by a second quantity and delete a second virtual card from the card area in response to a deletion operation on the second virtual card in the card area, where deleting different virtual cards corresponds to the same first resource increment.

In an embodiment of this application, reference may be made to operations 1601 and 1603 for specific implementations of operations 2110 and 2120, which will not be repeated in the embodiment of this application.
Operation 2130: Update, based on the second virtual card, a card deletion list for a first player account, the card deletion list being configured for recording deletions of virtual cards during a virtual battle.

For example, each player corresponds to one player account, and a first player account is a player account logged in on the current terminal.

In some embodiments, when a battle between the first player account and another player account begins, there is no virtual card deleted from the card deletion list. After deleting a virtual card, the terminal records the deletion of the virtual card during the battle.

In one embodiment, the card deletion list may include a card identifier and a deletion quantity of historically deleted cards.
Operation 2140: Determine, based on the card deletion list and a global deck, a personal deck for the first player account, the global deck being a deck shared by at least two player accounts in the same virtual battle.

In some embodiments, the global deck is configured to replenish the first player account with a virtual card in a battle round. To be specific, the terminal selects a virtual card from the global deck and performs card allocation. The allocated virtual card does not exist in the global deck. For instance, when all identical virtual cards of a single virtual card are allocated to an opposing player account, the virtual card does not exist in the global deck, and the virtual card cannot be allocated to the first player account.

In some embodiments, the personal deck is a virtual deck for a different player in the same battle. The personal deck is based on the global deck. Compared with the global deck, the personal deck lacks all or part of virtual cards. When a single virtual card is allocated from the global deck, the number of virtual cards in the global deck is reduced by 1, and the virtual card is also deleted from the personal deck. There are no virtual cards of which the number is a negative number in the personal deck. If the global deck reduces a virtual card that does not exist in the personal deck, the personal deck remains unchanged.

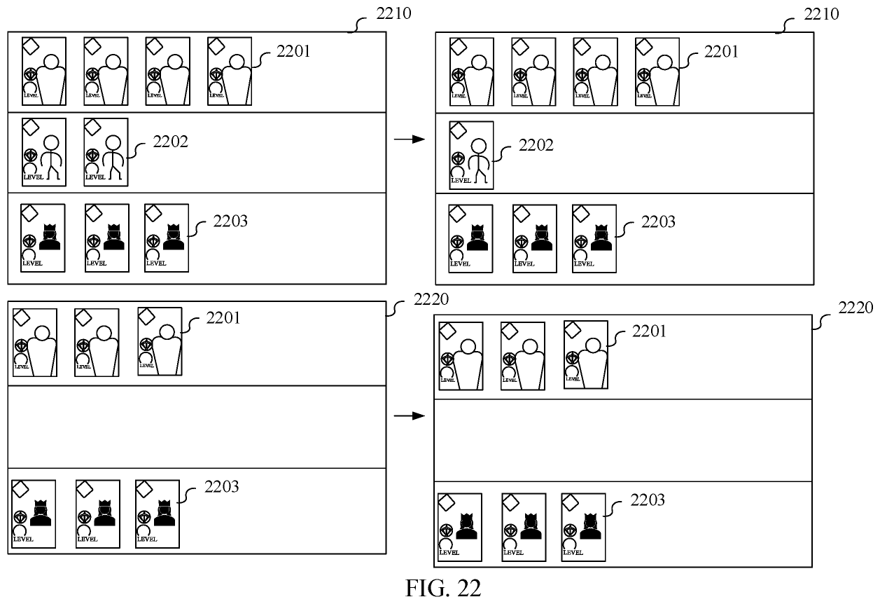

In an exemplary example, as shown in FIG. 22, the global deck 2210 includes 4 virtual cards 2201, 2 virtual cards 2202, and 3 virtual cards 2203. The personal deck 2220 includes 3 virtual cards 2201, 0 virtual card 2202, and 3 virtual cards 2203. When the terminal allocates a virtual card 2202 to the opposing player, the global deck 2210 has 1 virtual card 2202 remaining. Since the personal deck 2220 has no virtual card 2202, the personal deck 2220 remains unchanged.

In one embodiment, the terminal may select a virtual card from the personal deck and perform the allocation process, or may select a virtual card from the global deck and perform the allocation process. In one embodiment, the global deck and the personal deck may be decks of piece cards, decks of other types of virtual cards, or comprehensive decks of a plurality of types of virtual cards.

In an implementation, the terminal removes, from the global deck, part of virtual cards related to the deletion records according to deletions of virtual cards recorded in the card deletion list, thereby obtaining the personal deck.
Operation 2150: Allocate, based on the personal deck, a virtual card to the first player account when a card dealing requirement is present.

In one embodiment, scenarios where there is a card dealing requirement may include, allocating, based on the personal deck, the virtual card to the first player account when a battle round begins.

For example, the personal deck is a deck corresponding to the first player account. The card dealing process is implemented based on the personal deck when the battle round begins so that the virtual cards allocated to the first player account are more consistent with the current battle process, thereby helping the game player make precise strategic choices based on the current game situation and close-range interactions. Allocating virtual cards from the personal deck allows the game player to feel that the player's own deck is closely related to the strategy, enhancing the sense of immersion. This ensures a particular degree of predictability under dynamic card allocation, improves the game player's gaming experience, and also reduces the data processing quantity during the card allocation process based on the small-scale personal deck on the terminal.

In an implementation, when the card dealing requirement is present, the terminal allocates a virtual card to the first player account based on the presence of virtual cards in the personal deck for the first player account, and then synchronously deletes the virtual card from both the global deck and the personal deck.

The method provided in this embodiment of this application can select virtual cards based on historical deletions of virtual cards to obtain the personal deck. The personal deck is related to the player account's historical battle situations. Subsequently, by allocating virtual cards from the personal deck, the probability of the game player acquiring the desired virtual cards is increased, and the limitation of random card drawing on game player's strategy is reduced. Besides, the strategies of the auto chess are enriched.

In one embodiment, when a virtual card is deleted, the deleted virtual card returns to the global deck and participates in the allocation of subsequent virtual cards, while the deleted virtual card does not appear in the personal deck.

For example, as shown in FIG. 23, the global deck 2310 includes 4 virtual cards 2301, 1 virtual card 2302, and 3 virtual cards 2303. The personal deck 2320 includes 3 virtual cards 2301, 0 virtual card 2302, and 3 virtual cards 2303. After the terminal deletes a single virtual card in the card area that is identical to the virtual card 2302, the number of virtual cards 2302 in the global deck 2310 becomes 2, while the personal deck 2320 remains unchanged.

In some embodiments, when the card deletion list includes the card identifier and the deletion quantity of historically deleted cards, the historically deleted cards are virtual cards deleted within a historical time period. The terminal deletes, based on the card identifier and the deletion quantity in the card deletion list, virtual cards from the global deck to obtain the personal deck for the first player account.

In an implementation, the terminal deletes, according to the deletion quantity of the historically deleted cards and in accordance with the deletion quantity in the card deletion list, the virtual cards corresponding to the card identifier from the global deck, so as to obtain the personal deck for the current virtual player. The card identifier is the same for identical virtual cards. When the number of virtual cards corresponding to a card identifier in the global deck is less than or equal to the deletion quantity, the number of the virtual cards corresponding to the card identifier in the personal deck is reset to zero.

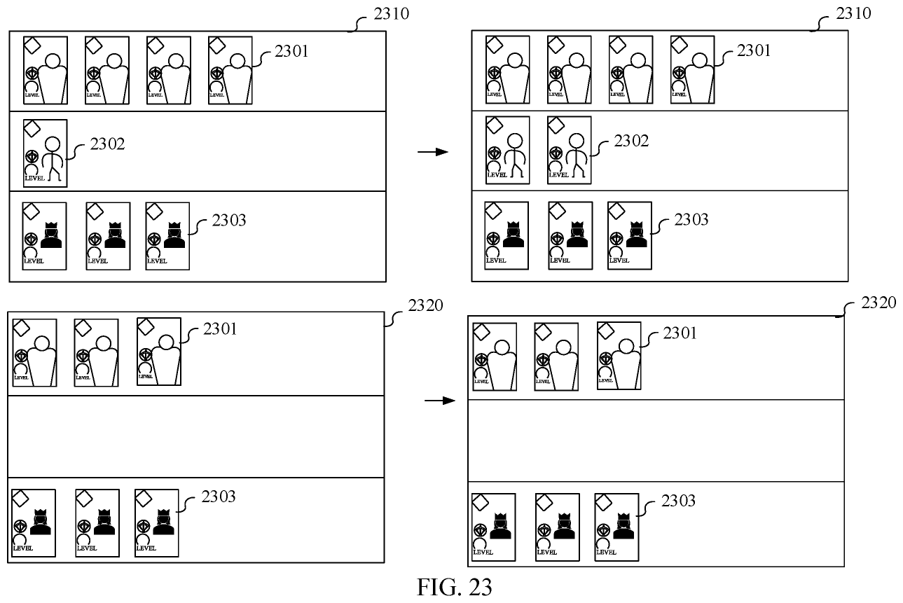

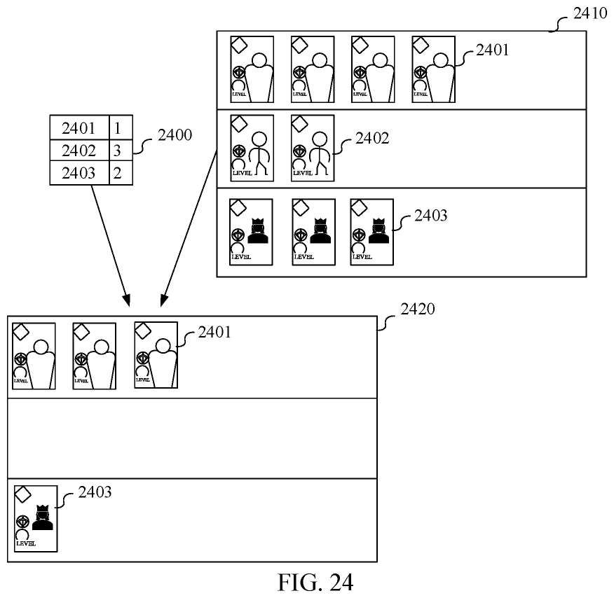

In an exemplary example, as shown in FIG. 24, the card deletion list 2400 records a deletion quantity of 1 for virtual card 2401, a deletion quantity of 3 for virtual card 2402, and a deletion quantity of 2 for virtual card 2403. The global deck 2410 includes 4 virtual cards 2401, 2 virtual cards 2402, and 3 virtual cards 2403. Since the number of virtual cards 2402 in the global deck is insufficient to subtract the deletion quantity recorded in the card deletion list 2400 (i.e., 2-3<0), the number of virtual cards 2402 in the personal deck 2420 is reset to zero. The personal deck 2420 then has 3 remaining virtual cards 2401 and 1 remaining virtual card 2403.

The above describes an operation process of deleting virtual cards based on the card deletion list, the deletion quantity, and the global deck. The deletion mechanism based on the card identifier and the deletion quantity allows game players to selectively delete specific virtual cards from the global deck. This flexible management method allows game players to delete virtual cards according to actual needs without affecting other virtual cards that do not need to be deleted, thereby improving management flexibility, helping avoid unnecessary accumulation of virtual cards, enhancing the user's sense of control, increasing the transparency of the operation process, and efficiently establishing a personal deck that is better suited to a player account.

Considering that the game player's intention in deleting virtual cards may not be to select the desired virtual cards, if the personal deck is updated, it would reduce the probability of acquiring the virtual cards that the game player actually needs. Based on the above reasoning, further, the terminal may delete, based on the deletion quantity, the virtual cards represented by the card identifier from the global deck when the deletion quantity corresponding to the card identifier reaches a quantity threshold, so as to obtain the personal deck for the first player account.

In an implementation, when deleting a virtual card, the terminal updates the card deletion list based on the card identifier of the virtual card. The terminal then determines whether the deletion quantity of the virtual cards represented by the card identifier reaches the quantity threshold. When the deletion quantity corresponding to the card identifier reaches the quantity threshold, the terminal deletes, according to the deletion quantity, the virtual cards represented by the card identifier from the global deck, so as to obtain the personal deck for the first player account.

In an exemplary example: when the number of virtual cards represented by the card identifier that are deleted by the terminal is 1, it is difficult for the terminal to determine whether the virtual card is an unwanted virtual card. The terminal updates the card deletion list but does not update the personal deck based on the updated card deletion list. When the number of virtual cards represented by the card identifier is 2 and the quantity threshold is 2, the terminal determines that the deletion quantity has reached the quantity threshold. The virtual card is not actually needed by the game player, and the probability of acquiring the virtual card needs to be reduced. The terminal then updates the card deletion list and deletes, according to the deletion quantity recorded in the updated card deletion list, the virtual cards represented by the card identifier from the global deck, so as to obtain the personal deck.

The above describes a limiting process in which the deletion quantity is constrained by the quantity threshold. By setting the quantity threshold, it is ensured that the deletion operation is only performed when the number of deletion operations on a virtual card reaches a particular condition, thereby avoiding unnecessary operational burden caused by overly frequent deletion operations. Game players can determine the timing of deletion based on the actual number of cards, and thus can manage their personal decks more efficiently and flexibly. The operational accuracy and game strategy are improved, and a more personalized and intelligent card management experience is provided for game players. Thus, the human-computer interaction efficiency is improved.

In one embodiment, the first player account may exchange unwanted virtual cards via an exchanging operation. To be specific, scenarios where there is a card dealing requirement further include card exchange.

In some embodiments, when receiving an exchanging operation on a fifth virtual card in the card area, the terminal allocates, based on the personal deck, the virtual card to the first player account, and deletes the fifth virtual card from the card area, the exchanging operation being configured for triggering exchanging the fifth virtual card for another virtual card.

In an implementation, the terminal selects, in response to a triggering operation on a card exchange button, a virtual card from the personal deck, displays the virtual card in the card area, and deletes the virtual card from both the personal deck and the global deck. At the same time, the terminal deletes the fifth virtual card from the card area.

The card exchange button is a control configured to trigger the exchanging operation. Based on the exchanging operation, the fifth virtual card may be replaced with another virtual card, such that a more suitable virtual card is selected for subsequent gameplay. The card resources in the personal deck can be fully utilized to flexibly meet diverse battle needs. The exchanging operation also helps game players better manage the virtual cards in their hands, avoiding unnecessary card accumulation and waste. This ensures that game players can flexibly optimize their decks, maintain maximum utilization of deck resources, and improve game fluency.

In one embodiment, after deleting the fifth virtual card, the terminal may update the card deletion list based on the fifth virtual card, so that the personal deck can be re-determined later, and virtual cards can be allocated to the first player account based on the personal deck.

In an implementation, when the card deletion list includes the card identifier and the deletion quantity, the terminal updates the deletion quantity for the fifth virtual card. If the card deletion list does not include the card identifier of the fifth virtual card, the terminal adds the card identifier of the fifth virtual card to the card deletion list and records the deletion quantity for the fifth virtual card. When the card deletion list includes the card identifier of the fifth virtual card, the terminal increases the deletion quantity for the fifth virtual card. In one embodiment, the virtual card allocated by the terminal may be selected from virtual cards other than the fifth virtual card (i.e., different from the fifth virtual card), or may include the fifth virtual card (i.e., identical to the fifth virtual card).

Regarding the case where the allocated virtual card is different from the fifth virtual card: In an implementation, the terminal deletes the fifth virtual card from the card area, as well as all virtual cards in the personal deck that are identical to the fifth virtual card, updates the card deletion list, then re-determines the personal deck, and allocates a virtual card from the personal deck.

Regarding the case where the allocated virtual card is identical to the fifth virtual card: In an implementation, the terminal increases, based on the card identifier and the quantity of the fifth virtual cards deleted, the deletion quantity for the fifth virtual card in the card deletion list, then re-determines the personal deck, and allocates a virtual card from the personal deck.

In the foregoing embodiments, when receiving the exchanging operation, the terminal updates the card deletion list in time according to the card exchange, so as to subsequently update the personal deck and ensure the accuracy of virtual cards in the personal deck. Afterwards, allocating a virtual card from the personal deck allows the game player to quickly obtain the desired virtual card via the exchanging operation. The efficiency of screening virtual cards is improved. Thus, the human-computer interaction efficiency is improved.

In some embodiments, when the card dealing requirement is present, the remaining virtual cards in the personal deck may or may not meet the card dealing requirement. For instance, when a single piece card is present in the global deck and all virtual cards identical to the virtual card in the personal deck have been deleted, the remaining virtual cards in the personal deck do not meet the card dealing requirement. In conclusion, scenarios where there is a card dealing requirement may include the following two cases.
Case 1: When there is a card dealing requirement and the remaining virtual cards in the personal deck meet the card dealing requirement, a virtual card is allocated to the first player account based on the personal deck.

In some embodiments, the remaining virtual cards in the personal deck meeting the card dealing requirement means that, under the card dealing rule indicated by the card dealing requirement, the terminal can select a virtual card from the personal deck. For instance, the terminal determines the allocation of a piece card according to the card dealing rule indicated by the card dealing requirement, and there is a piece card in the personal deck. This meets the card dealing requirement.
Case 2: When there is a card dealing requirement and the remaining virtual cards in the personal deck do not meet the card dealing requirement, a virtual card is allocated to the first player account based on the global deck.

In some embodiments, the remaining virtual cards in the personal deck not meeting the card dealing requirement means that, under the card dealing rule indicated by the card dealing requirement, the terminal cannot select a virtual card from the personal deck. For instance, the terminal determines the allocation of a piece card according to the card dealing rule indicated by the card dealing requirement, but the virtual cards in the personal deck have been completely removed due to the deletion operations, so that the terminal cannot allocate a virtual card from the personal deck. Nevertheless, there are piece cards in the global deck that return to the global deck due to the deletion operations.

In a scenario, the deletion quantity for a virtual card recorded in the card deletion list is greater than or equal to the number of virtual cards in the global deck, and the number of virtual cards in the personal deck is zero. In this case, the terminal can allocate the virtual card from the global deck but cannot allocate it from the personal deck.

For example, suppose there are three types of virtual cards: first cards, second cards, and third cards. All first and second cards in the global deck have been allocated, leaving only two third cards. When the deletion quantity for the third card in the card deletion list is two, the terminal cannot allocate a virtual card to the first player account based on the personal deck, and can only allocate a virtual card based on the global deck.

In one embodiment, when there is a card dealing requirement and the remaining virtual cards in the personal deck do not meet the card dealing requirement, the terminal may reset the personal deck.

In an implementation, the terminal updates the personal deck to make it consistent with the global deck, and clears the card deletion list. Subsequently, when receiving a deletion operation, the terminal updates the card deletion list. Afterwards, when there is a card dealing requirement, the terminal allocates a virtual card to the first player account based on the personal deck.

In one embodiment, when there is a card dealing requirement and the remaining virtual cards in the personal deck do not meet the card dealing requirement, the terminal may alternatively retain the personal deck. Thus, when the remaining virtual cards in the personal deck do not meet the card dealing requirement later, the terminal can continue to allocate a virtual card to the first player account based on the personal deck.

In the foregoing embodiments, whether the personal deck meets the card dealing requirement is determined. A virtual card is allocated to the first player account from the personal deck that meets the card dealing requirement. When the requirement is not met, a virtual card is allocated to the first player account from the global deck. The manner of allocating the virtual card to the first player account is determined flexibly, avoiding card dealing anomalies caused by the absence of allocatable virtual cards in the personal deck. Thus, the accuracy of virtual card dealing is ensured, and the granularity of card management is improved.

In some embodiments, the auto chess game may have some economic mechanisms. Under such economic mechanisms, the game player's intention in deleting virtual cards may not be to filter out unwanted virtual cards to obtain desired virtual cards, but rather to increase economic gains. For instance, within the first n battle rounds (where n is a positive integer), when receiving a deletion operation on all virtual cards in the card area, the terminal deletes all virtual cards in the card area and replenishes a particular quantity of virtual resources based on the quantity of virtual resources obtained from deleting the virtual cards.

In the foregoing embodiments, the terminal might misinterpret the deletion intention, leading to a reduced probability that the desired virtual card is allocated to the first player account.

To determine whether the purpose of the deletion operation on a virtual card is to remove the unwanted virtual card and to obtain a virtual card that the game player actually needs, in one embodiment, when the deletion operation on the second virtual card is not within the first n battle rounds, the terminal may update, based on the second virtual card, the card deletion list for the first player account, n being a positive integer.

In an implementation, the terminal first determines whether the current round is within the first n battle rounds. If so, the terminal does not update the card deletion list; and if not, the terminal updates, according to the deleted second virtual card, the card deletion list for the first player account.

In some embodiments, the first player account may have a first player skill that can obtain a buff via the deletion operation on the second virtual card. When using the first player skill, the terminal does not need to update the card deletion list, so as to avoid reducing the probability of acquiring a virtual card that the game player needs.

In one embodiment, when the first player account does not have the first player skill, the terminal updates, based on the second virtual card, the card deletion list for the first player account, the first player skill referring to a skill for obtaining a buff by deleting a virtual card.

In one embodiment, the above-mentioned buff may include an economic buff, an effect buff, an opportunity buff, a buff related to the number of deployed virtual pieces or the number of virtual cards in the card area, etc. For instance, deleting the second virtual card may provide additional virtual resources, increase skill strength, grant a free card exchange opportunity, or raise the upper limit on the number of deployed virtual pieces or the number of virtual cards in the card area.

In an implementation, the terminal first determines a player skill possessed by the first player account. When determining that the first player account possesses the first player skill, the terminal does not update the card deletion list. When determining that the first player account does not possess the first player skill, the terminal updates, based on the deleted second virtual card, the card deletion list for the first player account.

Regarding the manner of updating the card deletion list for the first player account: In an implementation, the terminal checks whether the card identifier of the deleted second virtual card exists in the card deletion list. When the card identifier exists in the card deletion list, the terminal updates the deletion quantity for the second virtual card. When the card identifier does not exist, the terminal adds the card identifier to the card deletion list and records the deletion quantity for the second virtual card.

In one embodiment, the number of second virtual cards deleted by the terminal may be one or more. The terminal updates, based on the number of second virtual cards deleted via the current deletion operation, the deletion quantity in the card deletion list.

In an embodiment of this application, the terminal determines, by determining either the current battle round or the player skill of the first player account, whether the game player's intention in performing the deletion operation on the second virtual card is to screen out the unwanted virtual card in order to acquire the desired virtual card. When determining that the game player's intention is as described above, the terminal updates, based on the card identifier and the number of the deleted second virtual cards, the deletion quantity for the second virtual card in the card deletion list, so that this can later be employed to update the personal deck. The efficiency of screening virtual cards is improved. Thus, the human-computer interaction efficiency is improved.

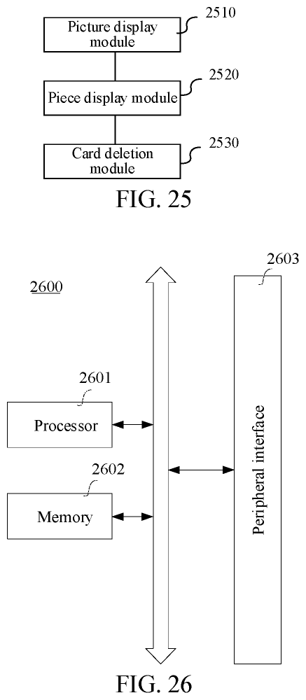

FIG. 25 illustrates a structural block diagram of an apparatus for updating resources in an auto chess provided by an exemplary embodiment of this application. The apparatus includes the following modules:
a picture display module 2510 configured to display an auto chess battle picture, the auto chess battle picture including a board area configured to display a deployed virtual piece and a card area configured to display unused virtual cards;
a piece display module 2520 configured to display a first virtual piece corresponding to a first virtual card in the board area in response to a use operation on the first virtual card in the card area, and reduce virtual resources by a first quantity, the first quantity being a resource consumption amount for using the first virtual card; and
a card deletion module 2530 configured to increase the virtual resources by a second quantity and delete a second virtual card from the card area in response to a deletion operation on the second virtual card in the card area.

In one embodiment, deleting different virtual cards corresponds to a same first resource increment, and the first resource increment is the second quantity.

In one embodiment, the card deletion module 2530 is further configured to display the first virtual piece corresponding to the first virtual card in the board area when the use operation on the first virtual card in the card area is received and the first virtual card is a piece card, where the piece card is a card configured to adjust the virtual piece in the board area, and the used first virtual card is deleted from the card area.

In one embodiment, the apparatus further includes a piece deletion module configured to: increase the virtual resources by a third quantity and delete the first virtual piece from the board area in response to a deletion operation on the first virtual piece in the board area, where deleting different virtual pieces corresponds to a same second resource increment, and deleting virtual pieces at different levels corresponds to the same second resource increment; and the second resource increment is the third quantity.

In one embodiment, the piece deletion module is further configured to: display first deletion prompt information when the deletion operation on the first virtual piece in the board area is received and a piece level of the first virtual piece is higher than a level threshold; and increase, in response to receiving a confirmation operation on the first deletion prompt information, the virtual resources by the third quantity, and delete the first virtual piece from the board area.

In one embodiment, the first virtual piece carries virtual equipment; and the piece deletion module is further configured to: add a third virtual card corresponding to the virtual equipment to the card area when the deletion operation on the first virtual piece in the board area is received, the third virtual card being an equipment card, and the equipment card being a card configured to wear the virtual equipment for at least one virtual piece.

In one embodiment, the card deletion module 2530 is further configured to: display second deletion prompt information when the deletion operation on the second virtual card in the card area is received and the second virtual card is a first-type virtual card; and increase, in response to a confirmation operation on the second deletion prompt information, the virtual resources by the second quantity, and delete the second virtual card from the card area.

In one embodiment, the card deletion module 2530 is further configured to: display batch deletion prompt information when a fourth virtual card that is identical to the second virtual card is present in the card area; and increase, in response to a confirmation operation on the batch deletion prompt information, the virtual resources by a fourth quantity, and delete the fourth virtual card from the card area, the fourth quantity being determined based on a number of the fourth virtual cards and the second quantity.

In one embodiment, the apparatus further includes: a list updating module configured to update, based on the second virtual card, a card deletion list for a first player account, the card deletion list being configured for recording deletions of virtual cards during a virtual battle; a personal deck updating module configured to determine, based on the card deletion list and a global deck, a personal deck for the first player account, the global deck being a deck shared by at least two player accounts in the same virtual battle; and a card allocation module configured to allocate, based on the personal deck, a virtual card to the first player account when a card dealing requirement is present.

In one embodiment, the card deletion list includes a card identifier and a deletion quantity of historically deleted cards, and the historically deleted cards are virtual cards deleted within a historical time period; and the personal deck updating module is further configured to: delete, based on the card identifier and the deletion quantity in the card deletion list, virtual cards from the global deck to obtain the personal deck for the first player account.

In one embodiment, the personal deck updating module is further configured to: delete, based on the deletion quantity, the virtual cards represented by the card identifier from the global deck when the deletion quantity corresponding to the card identifier reaches a quantity threshold, so as to obtain the personal deck for the first player account.

In one embodiment, the card allocation module is further configured to: allocate, based on the personal deck, the virtual card to the first player account when a battle round begins.

In one embodiment, the card allocation module is further configured to: allocate, based on the personal deck, the virtual card to the first player account when an exchanging operation on a fifth virtual card in the card area is received, and delete the fifth virtual card from the card area, the exchanging operation being configured for triggering exchanging the fifth virtual card for another virtual card.

In one embodiment, the list updating module is further configured to: update, based on the fifth virtual card, the card deletion list.

In one embodiment, the card allocation module is further configured to: allocate, based on the personal deck, the virtual card to the first player account when the card dealing requirement is present and remaining virtual cards in the personal deck meet the card dealing requirement.

The card allocation module is further configured to: allocate, based on the global deck, the virtual card to the first player account when the card dealing requirement is present and the remaining virtual cards in the personal deck do not meet the card dealing requirement. In one embodiment, the list updating module is further configured to: update, based on the second virtual card, the card deletion list for the first player account when the deletion operation on the second virtual card is not in the first n battle rounds, n being a positive integer; or update, based on the second virtual card, the card deletion list for the first player account when the first player account does not have a first player skill, the first player skill being a skill for obtaining a buff by deleting a virtual card.

In conclusion, this application can achieve, in addition to displaying the first virtual piece corresponding to the first virtual card in the board area and consuming the first quantity of virtual resources via the use operation on the first virtual card in the card area, the resource acquisition process of acquiring the second quantity of virtual resources exchanged with the second virtual card via the deletion operation on the second virtual card in the card area. This process not only enables the virtual card in the card area to be used, but also enables the virtual card to be specifically exchanged for the virtual resources, thereby enriching resource acquisition manners. Compared with a dynamically changed virtual piece during a virtual battle process, the exchange relationship between a static virtual card and virtual resources has high stability. Therefore, the second quantity of virtual resources obtained by exchange based on the virtual card is stable. The problem of resource acquisition complexity caused by excessively strong randomness in a game process is avoided so that a game player can understand the resource exchange process more efficiently. Thus, the human-computer interaction efficiency is improved.

According to the method provided in this embodiment, while eliminating the virtual store in traditional auto chess based on the playstyle characteristics of the cards, the cumbersome process in which a game player previously needed to purchase desired pieces from dozens of available pieces in the virtual store is replaced with a process in which the game system automatically deals virtual cards to the game player. This eliminates the need for the game player to manually select cards, thereby reducing the number of interactive operations required for the game player to acquire pieces, as well as the amount of information that the user needs to process.

According to the method provided in this embodiment, the virtual resources may alternatively be acquired by deleting the virtual cards, thereby enriching the ways to acquire the virtual resources and enriching strategies for auto chess games. Moreover, when a virtual card is deleted, the virtual resources are increased by a fixed quantity. This eliminates the need to calculate the quantity of resources increased or reduced according to the quality of the virtual cards, facilitating game players in quickly calculating the virtual resources and hence making relevant decisions. Thus, the human-computer interaction efficiency is further improved.

The apparatus provided in the foregoing embodiments is described only using the division of the foregoing functional modules as an example. In practice, the foregoing functions may be allocated to and completed by different functional modules as required. In other words, an internal structure of an apparatus is divided into different functional modules to complete all or some of the functions described above. In addition, the apparatus provided in the foregoing embodiments and the method embodiments belong to the same concept. Reference can be made to the method embodiments for the details of the implementation process, which will not be repeated here.

FIG. 26 illustrates a structural block diagram of a terminal 2600 provided by an exemplary embodiment of this application. The terminal 2600 may be a portable mobile terminal, for example, a smartphone, a tablet computer, an MP3 player, or an MP4 player. The terminal 2600 may alternatively be referred to as another name such as a user equipment or a portable terminal.

The terminal 2600 includes a processor 2601 and a memory 2602. The processor 2601 may include one or more processing cores, such as a 4-core processor or an 8-core processor. The memory 2602 may include one or more computer-readable storage media. The computer-readable storage medium may be tangible and non-transitory. In some embodiments, the terminal 2600 may alternatively include a peripheral interface 2603 and at least one peripheral device. The peripheral interface 2603 may be configured to connect the at least one peripheral device related to input/output (I/O) to the processor 2601 and the memory 2602. In some embodiments, the processor 2601, the memory 2602, and the peripheral interface 2603 are integrated on the same chip or circuit board. In some other embodiments, any one or two of the processor 2601, the memory 2602, and the peripheral interface 2603 may be implemented on an independent chip or circuit board. This is not limited in this embodiment.

An embodiment of this application further provides a computer-readable storage medium, having at least one instruction stored therein, the at least one instruction being loaded and executed by a processor to implement the method for updating resources in an auto chess as described in the foregoing embodiments.

An embodiment of this application further provides a computer program product, including computer instructions, the computer instructions being stored in a computer-readable storage medium, a processor acquiring the computer instructions from the computer-readable storage medium, and the processor executing the computer instructions to implement the method for updating resources in an auto chess as described in the foregoing embodiments.

The foregoing descriptions are merely exemplary embodiments of this application, but are not intended to limit this application. Any modification, equivalent replacement, or improvement made within the spirit and principle of this application shall fall within the protection scope of this application.

What is claimed is:

1. A method for updating resources of a first player account in an auto chess performed by a computing device, the method comprising:
displaying an auto chess battle picture, the auto chess battle picture comprising a board area configured to display a deployed virtual piece and a card area configured to display unused virtual cards;
in response to a use operation on a first virtual card in the card area:
displaying a first virtual piece corresponding to the first virtual card in the board area; and
reducing virtual resources of the first player account by a first quantity, the first quantity being a resource consumption amount for using the first virtual card; and
in response to a deletion operation on a second virtual card in the card area:
increasing the virtual resources of the first player account by a second quantity, the second quantity being greater than the first quantity; and
deleting a second virtual card from the card area.

2. The method according to claim 1, wherein the displaying a first virtual piece corresponding to the first virtual card in the board area comprises:
displaying the first virtual piece corresponding to the first virtual card in the board area when the first virtual card is a piece card configured to adjust the first virtual piece in the board area; and
deleting the first virtual card from the card area.

3. The method according to claim 1, further comprising:
in response to a deletion operation on the first virtual piece in the board area, increasing the virtual resources by a third quantity and deleting the first virtual piece from the board area,.

4. The method according to claim 3, wherein the increasing the virtual resources by a third quantity and deleting the first virtual piece from the board area comprises:
displaying first deletion prompt information when a piece level of the first virtual piece is higher than a level threshold; and
increasing, in response to receiving a confirmation operation on the first deletion prompt information, the virtual resources of the first player account by the third quantity, and deleting the first virtual piece from the board area.

5. The method according to claim 1, wherein the first virtual piece carries virtual equipment; and the method further comprises:
in response to a deletion operation on the first virtual piece in the board area, adding a third virtual card corresponding to the virtual equipment to the card area, the third virtual card being an equipment card configured to wear the virtual equipment for at least one virtual piece.

6. The method according to claim 1, wherein the increasing the virtual resources by a second quantity and deleting a second virtual card from the card area comprises:
displaying second deletion prompt information when the second virtual card is a first-type virtual card; and
increasing, in response to a confirmation operation on the second deletion prompt information, the virtual resources by the second quantity, and deleting the second virtual card from the card area.

7. The method according to claim 1, after the deleting the second virtual card from the card area, further comprising:
displaying batch deletion prompt information when a fourth virtual card that is identical to the second virtual card is present in the card area; and
in response to a confirmation operation on the batch deletion prompt information, increasing the virtual resources by a fourth quantity, and deleting the fourth virtual card from the card area, the fourth quantity being determined based on a number of the fourth virtual cards and the second quantity.

8. The method according to claim 1, after the deleting the second virtual card from the card area, further comprising:
updating, based on the second virtual card, a card deletion list for the first player account, the card deletion list being configured for recording deletions of virtual cards during a virtual battle;
determining, based on the card deletion list and a global deck, a personal deck for the first player account, the global deck being a deck shared by at least two player accounts in the same virtual battle; and
allocating, based on the personal deck, a virtual card to the first player account when a card dealing requirement is present.

9. The method according to claim 8, wherein the card deletion list comprises a card identifier and a deletion quantity of historically deleted cards, and the historically deleted cards are virtual cards deleted within a historical time period; and
the determining, based on the card deletion list and a global deck, a personal deck for the first player account comprises:
deleting, based on the card identifier and the deletion quantity in the card deletion list, virtual cards from the global deck to obtain the personal deck for the first player account.

10. The method according to claim 9, wherein the deleting, based on the card identifier and the deletion quantity in the card deletion list, virtual cards from the global deck to obtain the personal deck for the first player account comprises:
deleting, based on the deletion quantity, the virtual cards represented by the card identifier from the global deck when the deletion quantity corresponding to the card identifier reaches a quantity threshold, so as to obtain the personal deck for the first player account.

11. The method according to claim 8, wherein the allocating, based on the personal deck, a virtual card to the first player account when a card dealing requirement is present comprises:
allocating, based on the personal deck, the virtual card to the first player account when a battle round begins.

12. The method according to claim 8, wherein the allocating, based on the personal deck, a virtual card to the first player account when a card dealing requirement is present comprises:
allocating, based on the personal deck, the virtual card to the first player account when an exchanging operation on a fifth virtual card in the card area is received, and deleting the fifth virtual card from the card area, the exchanging operation being configured for triggering exchanging the fifth virtual card for another virtual card.

13. The method according to claim 8, wherein the allocating, based on the personal deck, a virtual card to the first player account when a card dealing requirement is present comprises:
allocating, based on the personal deck, the virtual card to the first player account when the card dealing requirement is present and remaining virtual cards in the personal deck meet the card dealing requirement; and
the method further comprising:
allocating, based on the global deck, the virtual card to the first player account when the card dealing requirement is present and the remaining virtual cards in the personal deck do not meet the card dealing requirement.

14. The method according to claim 8, wherein the updating, based on the second virtual card, a card deletion list for a first player account comprises:
updating, based on the second virtual card, the card deletion list for the first player account when the deletion operation on the second virtual card is not in first n battle rounds, n being a positive integer; or
updating, based on the second virtual card, the card deletion list for the first player account when the first player account does not have a first player skill, the first player skill being a skill for obtaining a buff by deleting a virtual card.

15. A computer device, comprising a processor and a memory, the memory having at least one instruction stored therein, and the at least one instruction, when loaded and executed by the processor, causing the computer device to implement a method for updating resources of a first player account in an auto chess including:
displaying an auto chess battle picture, the auto chess battle picture comprising a board area configured to display a deployed virtual piece and a card area configured to display unused virtual cards;
in response to a use operation on a first virtual card in the card area:
displaying a first virtual piece corresponding to the first virtual card in the board area; and
reducing virtual resources of the first player account by a first quantity, the first quantity being a resource consumption amount for using the first virtual card; and
in response to a deletion operation on a second virtual card in the card area:
increasing the virtual resources of the first player account by a second quantity, the second quantity being greater than the first quantity; and
deleting a second virtual card from the card area.

16. The computer device according to claim 15, wherein the method further comprises:
after the deleting the second virtual card from the card area:
displaying batch deletion prompt information when a fourth virtual card that is identical to the second virtual card is present in the card area; and
in response to a confirmation operation on the batch deletion prompt information, increasing the virtual resources by a fourth quantity, and deleting the fourth virtual card from the card area, the fourth quantity being determined based on a number of the fourth virtual cards and the second quantity.

17. The computer device according to claim 15, wherein the method further comprises:
after the deleting the second virtual card from the card area:
updating, based on the second virtual card, a card deletion list for the first player account, the card deletion list being configured for recording deletions of virtual cards during a virtual battle;
determining, based on the card deletion list and a global deck, a personal deck for the first player account, the global deck being a deck shared by at least two player accounts in the same virtual battle; and
allocating, based on the personal deck, a virtual card to the first player account when a card dealing requirement is present.

18. A non-transitory computer-readable storage medium, having at least one instruction stored therein, and the at least one instruction, when loaded and executed by a processor of a computer device, causing the computer device to implement a method for updating resources of a first player account in an auto chess including:
displaying an auto chess battle picture, the auto chess battle picture comprising a board area configured to display a deployed virtual piece and a card area configured to display unused virtual cards;
in response to a use operation on a first virtual card in the card area:
displaying a first virtual piece corresponding to the first virtual card in the board area; and
reducing virtual resources of the first player account by a first quantity, the first quantity being a resource consumption amount for using the first virtual card; and
in response to a deletion operation on a second virtual card in the card area:
increasing the virtual resources of the first player account by a second quantity, the second quantity being greater than the first quantity; and
deleting a second virtual card from the card area.

19. The non-transitory computer-readable storage medium according to claim 18, wherein the method further comprises:
after deleting the second virtual card from the card area:
displaying batch deletion prompt information when a fourth virtual card that is identical to the second virtual card is present in the card area; and
in response to a confirmation operation on the batch deletion prompt information, increasing the virtual resources by a fourth quantity, and deleting the fourth virtual card from the card area, the fourth quantity being determined based on a number of the fourth virtual cards and the second quantity.

20. The non-transitory computer-readable storage medium according to claim 18, wherein the method further comprises:
after deleting the second virtual card from the card area:
updating, based on the second virtual card, a card deletion list for the first player account, the card deletion list being configured for recording deletions of virtual cards during a virtual battle;
determining, based on the card deletion list and a global deck, a personal deck for the first player account, the global deck being a deck shared by at least two player accounts in the same virtual battle; and
allocating, based on the personal deck, a virtual card to the first player account when a card dealing requirement is present.
